(19) United States
(12) Patent Application Publication
(10) Pub. No.: US 2004/0163126 A1
(43) Pub. Date: Aug. 19, 2004

(54) Methods and apparatus for delivering a computer data stream to a video appliance with a network interface device

(75) Inventors: Bruce A. Phillips, Erie, CO (US); Steven M. Casey, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO

(21) Appl. No.: 10/448,249

(22) Filed: May 29, 2003

Related U.S. Application Data
(63) Continuation-in-part of application No. 10/367,597, filed on Feb. 14, 2003.
(63) Continuation-in-part of application No. 10/356,364, filed on Jan. 31, 2003.
(63) Continuation-in-part of application No. 10/356,688, filed on Jan. 31, 2003.
(63) Continuation-in-part of application No. 10/356,338, filed on Jan. 31, 2003.
(63) Continuation-in-part of application No. 10/367,596, filed on Feb. 14, 2003.

(51) Int. Cl. H04N 7/173; H04N 7/16

(52) U.S. Cl. 725/120; 725/119; 725/131; 725/140

(57) ABSTRACT

Methods and apparatus are provided for delivering a data stream having a computer video signal to a video appliance within a customer premises. A transport medium internal to the customer premises is isolated from a transport medium external to the customer premises such that operational changes to one of the internal and external transport media do not affect the other of the internal and external transport media. The data stream is received from the external transport medium. A television signal is also received from the external transport medium. The computer video signal is combined with the television signal, and the combined signal is transmitted to the video appliance over the internal transport medium.

### CROSS-REFERENCES TO RELATED APPLICATIONS

This application is a continuation-in-part of U.S. patent application Ser. No. 10/367,597, entitled “SYSTEMS AND METHODS FOR PROVIDING APPLICATION SERVICES VIA A NETWORK INTERFACE DEVICE,” filed Feb. 14, 2003 by Steven M. Casey et al.; is a continuation-in-part application of U.S. patent application Ser. No. 10/356,364, entitled “PACKET NETWORK INTERFACE DEVICE AND SYSTEMS AND METHODS FOR ITS USE,” filed Jan. 31, 2003 by Bruce A. Phillips et al.; is a continuation-in-part application of U.S. patent application Ser. No. 10/356,688, entitled “SYSTEMS, METHODS AND APPARATUS FOR PROVIDING A PLURALITY OF TELECOMMUNICATION SERVICES,” filed Jan. 31, 2003 by Bruce A. Phillips et al.; is a continuation-in-part application of U.S. patent application Ser. No. 10/356,338, entitled “CONFIGURABLE NETWORK INTERFACE DEVICE AND SYSTEMS AND METHODS FOR ITS USE,” filed Jan. 31, 2003 by Bruce A. Phillips et al.; and is a continuation-in-part application of U.S. patent application Ser. No. 10/367,596, entitled “SYSTEMS AND METHODS FOR DELIVERING A DATA STREAM TO A VIDEO APPLIANCE,” filed Feb. 14, 2003 by Steven M. Casey et al., the entire disclosure of each of which is herein incorporated by reference for all purposes.

### BACKGROUND OF THE INVENTION

This application relates generally to telecommunication systems. More specifically, this application relates to methods and systems for delivering a computer data stream to a video appliance.

In recent years, as recreational use of the Internet has steadily increased, there has been a generally corresponding decrease in the average number of hours spent watching television. These concomitant trends are widely believed to be related, and to reflect the fact that the availability of the Internet has caused a shift in the use of leisure time by individuals away from watching television and towards using the Internet. Accordingly, a number of attempts have been made to integrate television watching with Internet usage, but these suffer from a number of deficiencies.

For example, one attempt that has been made is in the form of variety of commercially available products called “WebTV Internet Terminals,” available from such manufacturers as Sony, Thomson Consumer Electronics, and Philips. Such products are designed to interface directly with a consumer's home television and thereby provide access to the Internet through the television. A wireless keyboard may be provided to act as an input device to the terminal. In some instances, the picture-in-picture (“PIP”) feature of the consumer's television may be used to provide a small PIP screen that shows a television broadcast signal while the user is using the main screen for Internet access. While this arrangement may be suitable for some applications, it is sharply limited in utility by the fact that, in effect, it is merely turning an existing television set into a monitor for an Internet-access device. In particular, such systems effectively remove the versatility afforded by separate Internet-access and broadcast-television-access devices in an effort to integrate those activities. For example, if there are two individuals within a household, one of which wants only to watch television and one of which only wishes to access the Internet, such systems are unable to accommodate that behavior.

Such a deficiency exists in other proposals as well. For example, some manufacturers have marketed modified television sets that have built-in Internet-access capability or have marketed computers that include television viewing capability. There is accordingly a persistent need in the art for methods and systems that retain the flexibility of separate Internet-access and television devices while still providing the capability of an integration of that access.

### BRIEF SUMMARY OF THE INVENTION

Embodiments of the invention thus provide methods and apparatus for delivering a data stream having a computer video signal to a video appliance within a customer premises. A transport medium internal to the customer premises is isolated from a transport medium external to the customer premises such that operational changes to one of the internal and external transport media do not affect the other of the internal and external transport media. The data stream is received from the external transport medium. A television signal is also received from the external transport medium. The computer video signal is combined with the television signal, and the combined signal is transmitted to the video appliance over the internal transport medium.

In some embodiments, the computer video signal is converted to a converted television video signal, which is combined with the television signal. The converted television signal may be rf modulated, thereby allowing the converted television video signal to be selected for display on the video appliance by tuning the video appliance. In some instances, the converted television video signal may be stored. In such cases, the stored converted television video signal may be retrieved prior to combining it with the television signal. It is also possible to accommodate a second data stream having a second computer video signal by receiving the second data stream from the external transport medium and combining the second computer video signal with the television signal. The second computer video signal may be converted to a second converted television video signal, which may be combined with the television video signal. In embodiments where there are two or more such data streams, the converted television video signal may be rf modulated with a first modulation and the second converted television video signal may be rf modulated with a second modulation; this allows either of the converted television video signals to be selected for display on the video appliance by tuning the video appliance. The converted television video signal may be displayed on the video appliance, such as with a picture-in-picture (“PIP”) capability of the video appliance.

In some embodiments, the data stream may also be transmitted to a computational device within the customer premises over the internal transport medium. In some such instances, receiving the data stream may be performed in response to a request for the data stream received from the computational device over the internal transport medium.

The television signals may be determined from encoded telecommunication information that is received from the external transport medium. For example, the encoded telecommunication information may be decoded with an addressable set-top box disposed external to the customer premises, with the television signal being generated from the decoded telecommunication information. In some cases, an instruction may be received to change a state of the addressable set-top box, with the state of the addressable set-top box then being changed in accordance with the received instruction.

In other embodiments, a network interface device is provided. The network interface device includes an isolation device adapted to isolate a transport medium internal to a customer premises from a transport medium external to the customer premises such that operational changes to one of the internal and external transport media do not affect the other of the internal and external transport media. A first interface is coupled with the isolation device and adapted to communicate with the external transport medium. A second interface is coupled with the isolation device and adapted to communicate with the internal transport medium. An internet data module is coupled with the first and second interfaces and adapted to receive a television signal and a data stream having a computer video signal from the external transport medium. The internet data module is further adapted to transmit a combination of the television signal and the computer video signal to a video appliance over the internal transport medium.

The internet data module may include a conversion element, a combiner, and a processor. The conversion element is adapted to convert the computer video signal to a converted television video signal. The combiner is adapted to combine the converted television video signal with the television signal. The processor is provided in communication with, and adapted to coordinate operation of, the conversion element and the combiner. In some instances, the internet data module may additionally include an rf modulator adapted to modulate the converted television video signal, with the processor in communication with, and adapted to coordinate operation of, the rf modulator. The internet data module may also comprise a storage device adapted to store the converted television signal. Alternatively, the processor may be configured for communication with a storage device disposed external to the internet data module.

Multiple data streams may be accommodated in some embodiments. For example, the conversion element may be further adapted to convert a second computer video signal to a second converted television video signal. The combiner may be further adapted to combine the second converted television video signal with the converted television video signal and the television signal. Such a configuration provides the internet data module with the capability to receive a second data stream having the second computer video signal and to transmit a combination of the television signal, the computer video signal, and the second computer video signal to the video appliance. In some cases, the internet data module may additionally comprise a first rf modulator adapted to modulate the converted television video signal with a first modulation and a second rf modulator adapted to modulate the second converted television video signal with a second modulation.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a capital-letter sublabel is associated with a reference numeral to denote one of multiple similar components. When reference is made to a reference numeral without specification to an existing sublabel, it is intended to refer to all such multiple similar components.

FIGS. 1A-1G provide schematic illustrations of embodiments of the invention that use demarcation and application devices to provide a network interface system;

FIGS. 2A-2C provide schematic illustrations of network interface systems according to embodiments of the invention;

FIG. 3 provides a schematic illustration of the functionality of a network interface device configured to deliver a computer data stream to a video appliance;

FIG. 4 provides a schematic illustration of an internet data module that may be provided as part of a network interface device in embodiments of the invention;

FIGS. 5A and 5B are schematic diagrams of structures computer-video-TV-video converters used in embodiments of the invention; and

FIG. 6 is a flow diagram illustrating methods of delivering the computer data stream according to embodiments of the invention.

### DETAILED DESCRIPTION OF THE INVENTION

1. Introduction

Embodiments of the invention provide methods and systems for delivering a computer data stream to a video appliance using a network interface device. In particular, specific configurations permit a video appliance to be used simultaneously to view television video signals and to view computer video signals. In some instances, the computer video signals are simultaneously being transmitted to a computational device, permitting a viewer of the video appliance to monitor the computer video signals while watch watching the television video signals.

As used herein, the term “television video signals” refers to electronic signals provided according to a protocol that permits their representation in the form of visual images on a television. Examples of television video signals thus includes signals provided in accordance with protocols established by the National Television System Committee (“NTSC”) in North America, signals provided in the Phase Alternation Line (“PAL”) format common for western European and Australian television, signals provided in the PAL-M format common for much of Brazilian television, signals provided in the PAL-N format common for Argentinean television, signals provided in the Sequentiel Couleur Avec Mémoire (“SECAM”) format used for French color television and in parts of the Middle East, and the like. As used herein, the term “computer video signals” refers to electronic signals provided according to a protocol for presentation in the form of visual images by a computer. Examples of computer video signals thus includes signals provided in accordance with the Video Graphics Array (“VGA”) protocols (640×480 pixels), the SuperVGA (“SVGA”) protocols (800×600 pixels), the eXtended Graphics Array (“XGA”) protocols (1024×768 pixels), the XGA-2 protocols (1152×864 pixels), the SuperXGA (“SXGA”) protocols (1280×1024 pixels), and the like.

Simultaneous display of the television and computer video signals may be enabled by an internet data module comprised by the network interface device (“NID”), detailed descriptions of which are provided below for specific embodiments. In some instances, the internet data module may be embedded within the NID. Furthermore, the NID may be configured in some embodiments to provide additional application services supplementary to those provided with the internet data module. The scope of such supplementary application services may be broad, and includes such examples as may be broadly classified as including communications application services, informational application services, diagnostic application services, monitoring application services, and data storage application services, among others. Several specific examples of supplementary application services that may be provided are discussed in greater detail below.

In embodiments of the invention, the NID is capable of interfacing between a customer premises and a telecommunication service provider's network. In some instances the interfacing capability of the NID may additionally include a “demarcation capability,” which is described in further detail below with specific examples of how the demarcation capabilities arise in different embodiments. In some instances, the NID may additionally include other capabilities, including, for example, the capability to separate received telecommunication information into discrete sets; the capability to process certain of the separated sets independently from other sets; and/or the capability to transmit different of the separated sets to different locations, perhaps through the use of different interfaces.

In describing embodiments of the invention, references to “customer premises” are intended to refer to physical structures under the control of a customer through ownership, leasehold, or any other property right. The term is not intended to encompass open real property external to the physical structures, even if such open real property is also under the control of the customer. Such a definition reflects differences in accessibility to the physical structures and surrounding open real property. Access to the physical structures generally requires the presence of the customer or a representative of the customer, while access to the surrounding open real property may be obtained by permission from customer, through an easement, or by other means that does not require the physical presence of the customer. Thus, for example, in the case of a residential customer, the customer premises may correspond to the customer's home, but does not include the yard surrounding the home. Access to the yard may be obtained even when the customer is not home, such as when the customer is at work, is shopping, or is otherwise unavailable to be physically present.

In the case of multiple-dwelling units (“MDU”), each dwelling unit may correspond to a distinct customer premises. In such cases, the MDU defines a plurality of customer premises, which may sometimes be located within a single physical structure, such as in the case of an apartment building or hotel MDU. There may be locations within the single physical structure that do not correspond to customer premises because they are not under the control of the customer, but are rather under the control of another party such as a landlord or hotel management. Similar to the yard example above, accessibility of such locations may be provided even when the customer is not present, such as through permission of the other party.

As used herein, the term “telecommunication information” is broadly defined to include any information that can be transmitted or carried by a telecommunication service provider's network (e.g., the Public Switched Telephone Network or “PSTN”) or by any other telecommunication network, including but not limited to the Internet. Such information includes, for example, voice signals (e.g., Plain Old Telephone Service or “POTS,” as the term is known to those skilled in the art), audio and video signals (encoded in any standard and/or proprietary, digital and/or analog format now known or hereafter developed, using any of a variety of means known to those skilled in the art, such as HDTV, NTSC, PAL, and SECAM formatting, as well as, for example any of the MPEG digital encoding and/or compression algorithms), and data. Such data can be formatted according any of a variety of protocols familiar in the art, including in particular the Internet Protocol, and may include computer video signals such as those provided in accordance with the Video Graphics Array (“VGA”) protocols (640×480 pixels), the SuperVGA (“SVGA”) protocols (800×600 pixels), the eXtended Graphics Array (“XGA”) protocols (1024×768 pixels), the XGA-2 protocols (1152×864 pixels), the SuperXGA (“SXGA”) protocols (1280×1024 pixels), and the like.

In this application, the term “telecommunication service provider” refers to any entity that provides telecommunication service to a customer's premises, including, merely by way of example, incumbent local exchange carriers, competitive local exchange carriers, cable television carriers, and satellite providers, to name a few. In contrast, the term “telecommunication information provider,” means any entity that is capable of serving as a source of telecommunication information. In many cases, a particular entity may be considered both a telecommunication service provider and a telecommunication information provider, for instance, when a local exchange carrier provides Internet service to a customer, as well as the external transport medium attached to that customer's premises. In other cases, the two may be separate entities. For instance, according to certain embodiments of the invention, a cable television provider could contract with a local exchange carrier to provide broadcast television signals to a customer premises using the local exchange carrier's network and/or an external transport medium operated by the local exchange carrier.

The term “telecommunication information set” is intended to describe a discrete subset of the telecommunication information transmitted across a particular transport medium and/or received by a device having demarcation capabilities. Generally, the telecommunication information that is classified part of a particular information set shares a common characteristic. Merely by way of example, an information set can comprise telecommunication information of a particular type, such as voice, IP data, encoded video, and such; information associated with a particular application, such as information assigned to a specific IP port, as is known in the art; information addressed to or received from a particular device or network segment; information received within a particular reception window; and the like.

In certain embodiments, demarcation capabilities can support the one-way flow of telecommunication information, such as exemplified by the case of a simple set top box, which can receive data representing a video signal, decode that data, and transmit a video signal to an attached television. In other embodiments, demarcation capabilities can support bidirectional flow of telecommunication information. In still other embodiments, the demarcation capability can support both unidirectional and bidirectional information flows simultaneously, depending on the type of telecommunication information transmitted or the source of the information.

The demarcation capabilities may also function to isolate the telecommunication service provider's network from the network at the customer premises. As described in detail below, the service provider's network is one example of an “external transport medium” and the customer's network is one example of an “internal transport medium.” The external transport medium and internal transport medium are each examples of a “transport medium,” which is used herein to describe any cable, wire, or other medium capable of carrying telecommunication information, including, but not limited to, twisted pair copper wiring (shielded or unshielded, including, for example, unshielded cables complying with industry-standard categories 3, 5, 5e and 6), optical fiber, and coaxial cable. Other examples of transport media include universal serial bus (“USB”) cable, cable complying with the Institute of Electrical and Electronics Engineers' (“IEEE”) 1394 standard, as well as any medium capable of complying with the many local-area networking standards known in the art. The preceding are examples of transport media that comprise physical media, but the invention is not limited to the use of physical media. In other embodiments, a transport medium may comprise any of a wide variety of wireless transmissions, including infra-red transmissions, radio frequency (“RF”) transmissions, and transmissions complying with standards developed by any of the IEEE's working groups governing wireless communication (e.g., the 802.11, 802.15, 802.16 and 802.20 working groups), as well as point-to-point microwave, satellite, cellular/PCS, and/or ultra wideband transmissions, among others.

In certain embodiments, demarcation capabilities can define an active demarcation point, serving to isolate the external transport medium from the internal transport medium (perhaps via an isolation device, discussed below), such that operational changes in one network do not affect the other network. “Operational changes” can include any changes in the structure, topology, format, protocol, bandwidth, media, and/or other operational parameters of a network. This isolation feature can provide many benefits; for instance, the demarcation capability can be realized by a disclosed interface between a customer premises and a provider's network, allowing the provider to implement changes in its network without disrupting the service provided to the customer.

Likewise, the isolation of the internal transport medium from the external transport medium can allow for any variety of customer premises equipment (“CPE”) to be used at the customer premises without fear that the equipment might be incompatible with a particular telecommunication service provider's standards. “Customer premises equipment” and “CPE” are intended to refer to any device that sends, receives, or otherwise utilizes telecommunication information. Moreover, the demarcation capabilities might serve to couple a plurality of external and/or internal transport media, allowing interoperation among them all, and to provide the same isolation features among all of these media.

In this way, certain aspects of the demarcation capabilities can allow for sales of a wide variety of CPE on a consumer electronics model, instead of the proprietary model necessitated by many of today's telecommunication networks, where, for example, differing implementations of xDSL among providers virtually force consumers to purchase modems from the providers to ensure compatibility between the modem and the provider's xDSL implementation. By isolating the topologies of the external and internal transport media, embodiments of the present invention can create a disclosed interface between the provider's network and the customer's network, allowing much greater flexibility in both the provider's networking options and the customer's choice of telecommunication appliances. Those skilled in the art will recognize that these and many other benefits result from embodiments of the invention.

In accordance with other embodiments, the isolation abilities also allow insulation between different transport media coupled to the internal and external transport media in order. This may permit, for example, preventing unwanted telecommunication information of one network from entering the other network. For instance, a demarcation capability of a network interface system in accordance with particular embodiments can serve to prevent propagation of certain telecommunication information from an internal network (including particular signals or frequencies) into one or more external transport media, preventing interference in the internal transport medium from interfering with the telecommunication service provider's network. In similar fashion, demarcation capabilities can prevent the contamination of the internal transport medium with unwanted information from the external medium, interference between two or more external transport media coupled, and unwanted interference or crosstalk between multiple internal media.

In some embodiments, the isolation of the internal transport medium from the external transport medium resulting from the demarcation capabilities also allows enhanced security to be provided for the customer and/or to control customer access to certain features or services. For instance, those skilled in the art will recognize that demarcation capabilities can prevent unauthorized access to the customer's data network, such as by a telecommunication service provider and/or a third party, or can screen or filter telecommunication information entering or leaving the customer's premises. This enables features such as parental controls to be placed on incoming and outgoing information, as well as filtering of outgoing sensitive information, such as credit card information and the like.

Further, according to certain embodiments, the demarcation capabilities may be used to define a consolidation point for all telecommunication information entering or leaving the customer premises. Definition of such a consolidation point permits a variety of enhanced features to be provided to the entire premises, including features such as caller identification, premises-wide telephone, video and data distribution, content on demand, including video, audio, and/or data on demand, and the like. These and other features resulting from demarcation capabilities also allow for a variety of new and useful telecommunication applications to be provided to customers. Specific details of some exemplary applications are discussed below; given the disclosure herein, those skilled in the art can appreciate the wide variety of such applications that are possible using various embodiments of the invention.

In a number of embodiments, the demarcation capability is applied specifically to a customer premises, thereby separating a transport medium internal to the customer premises from a transport medium external to the customer premises. Moreover, the demarcation is exploited to provide the internet data module, perhaps with supplementary addressable application devices, in a configuration that permits internet, television, and perhaps other services to be provided to the entire premises. For example, the internet data module and other addressable application devices may be disposed external to the customer premises, as may be one or more processors. The internet data module and other addressable application devices may be adapted to interface with the transport medium internal to the customer premises, and the processors may be adapted to selectively process telecommunication information originating from the transport medium external to the customer premises. Internet, television, and other applications may be implemented through transmission of the processed telecommunication information from the processors to the internet data module and other addressable application devices. Not only does such a configuration permit applications to service the entire premises, disposing the internet data module and other addressable application devices external to the customer premises makes them easily accessible by technicians as need for service or to change their operational states.

2. Organizational Configurations

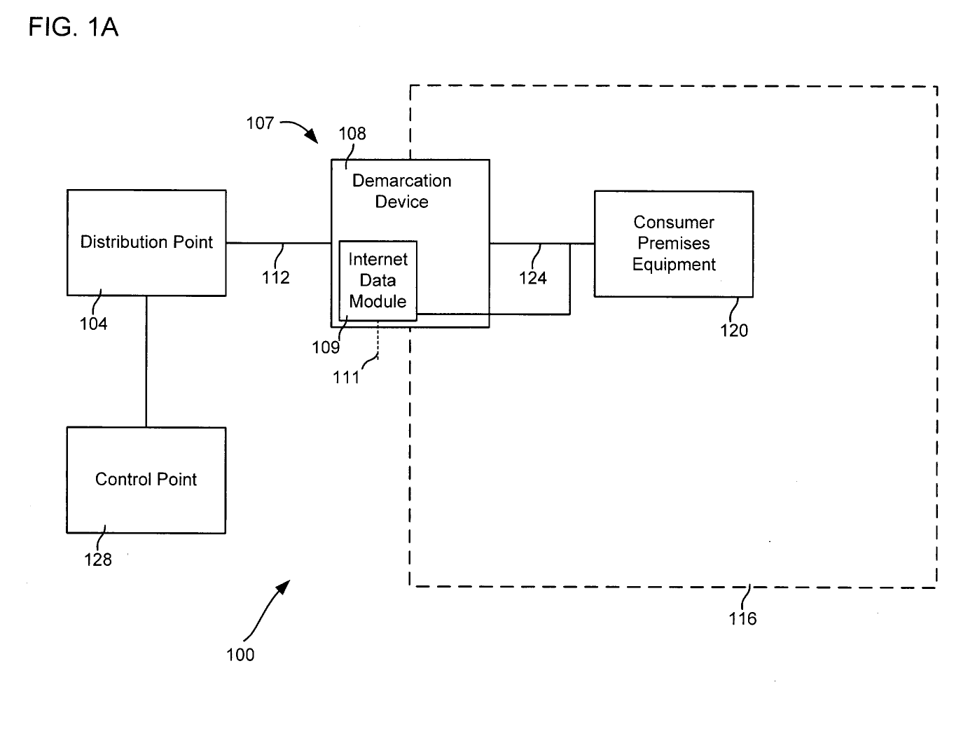

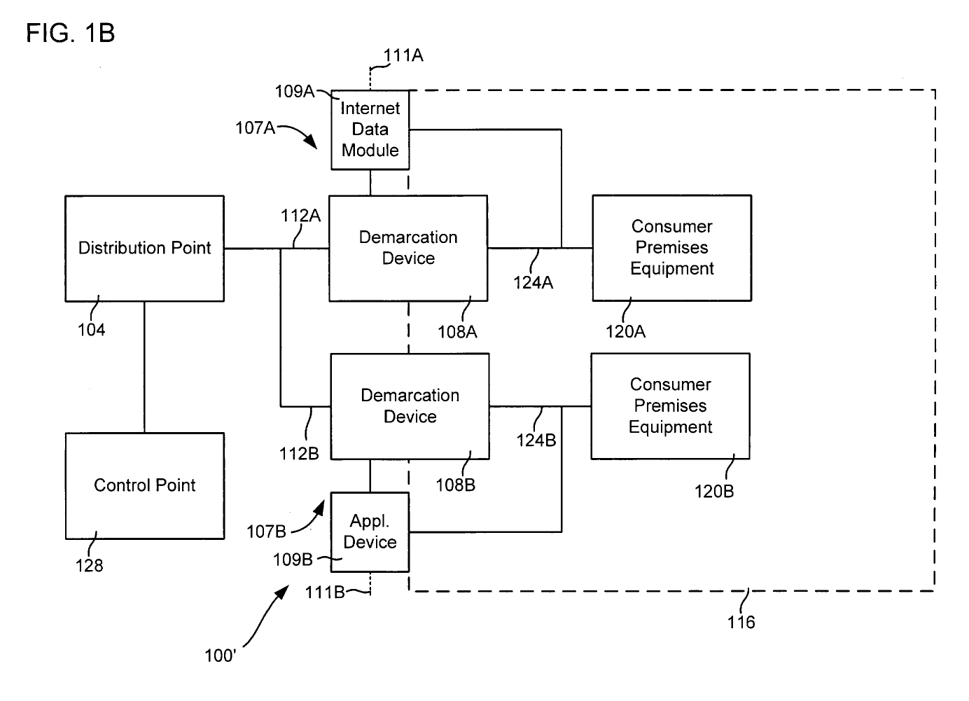

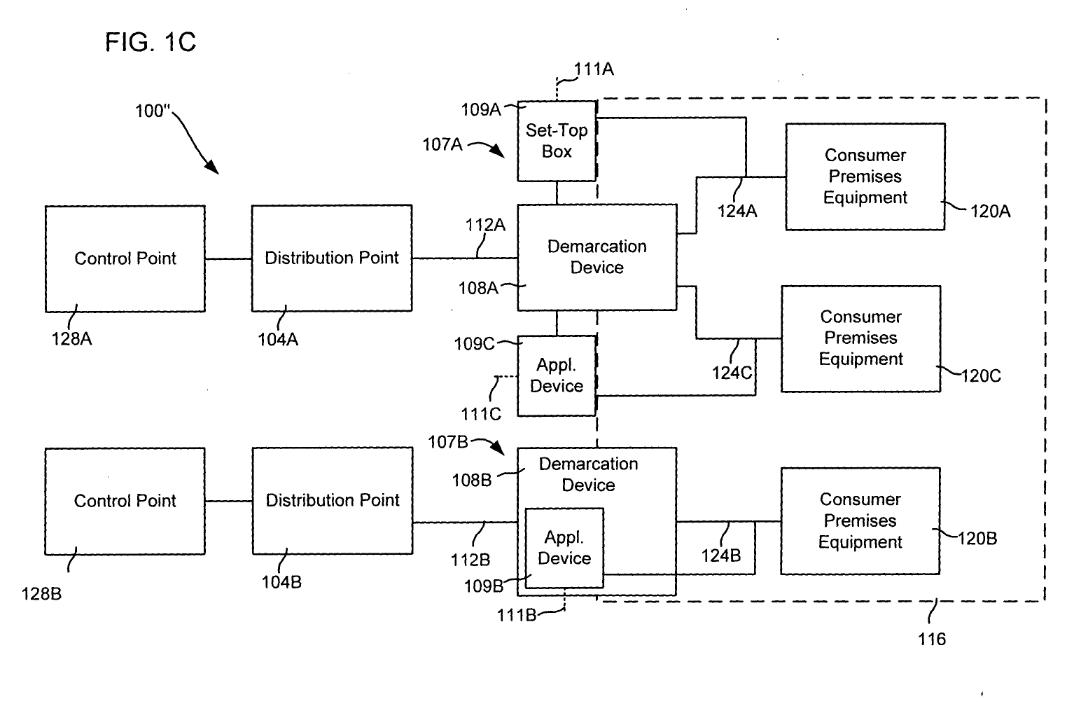

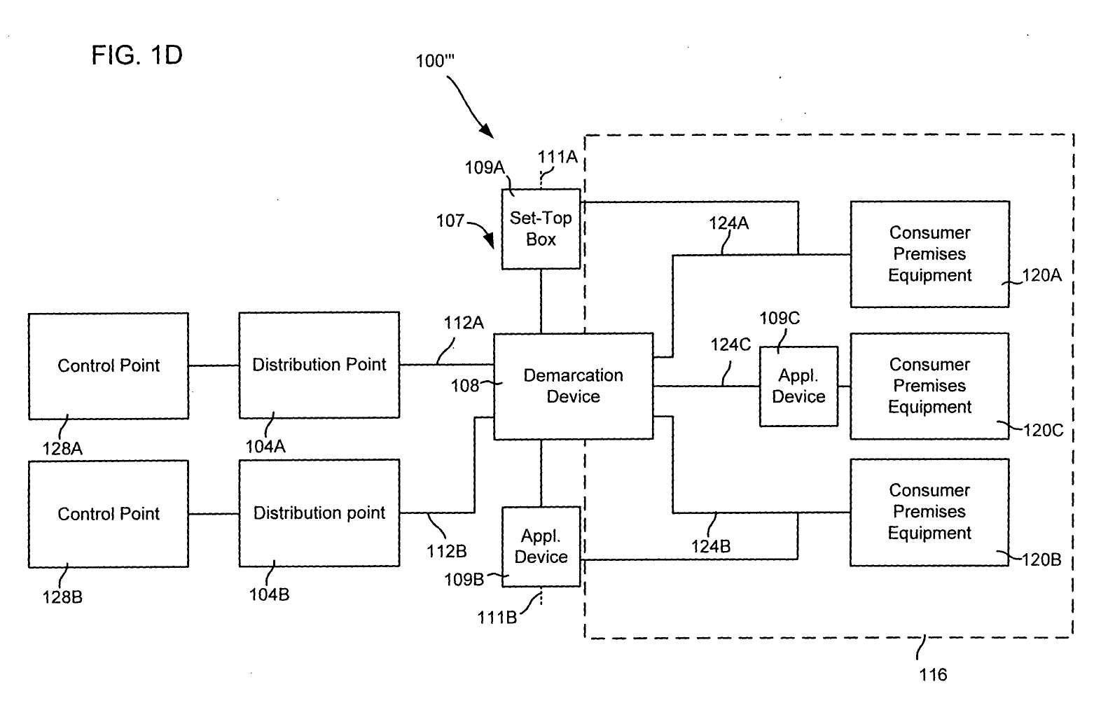

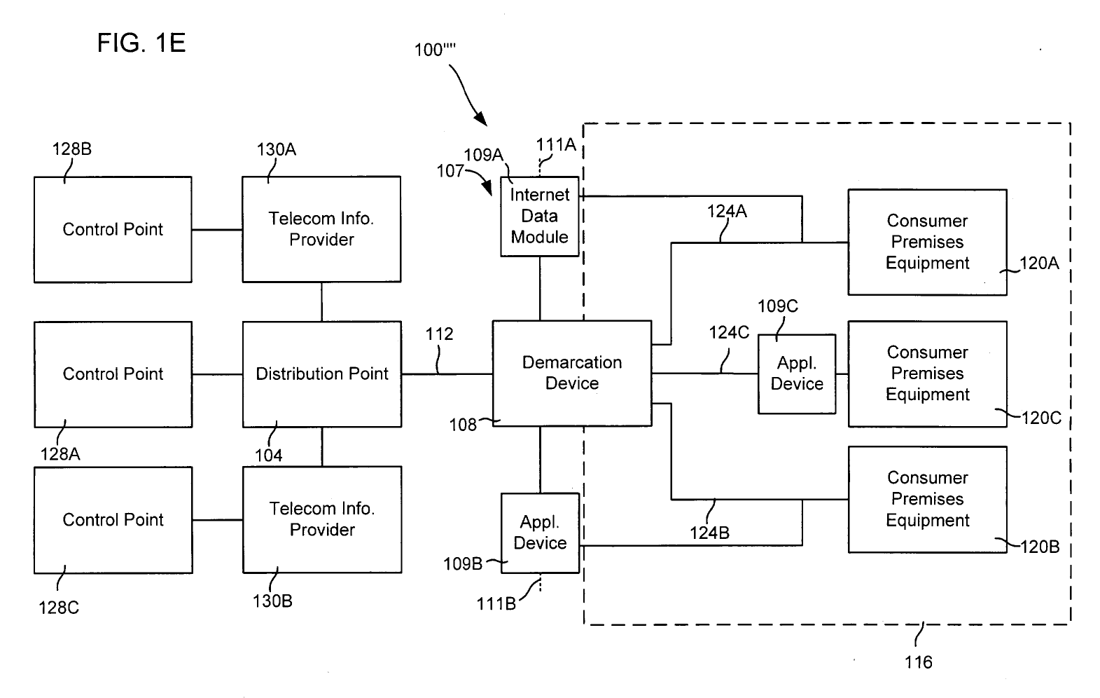

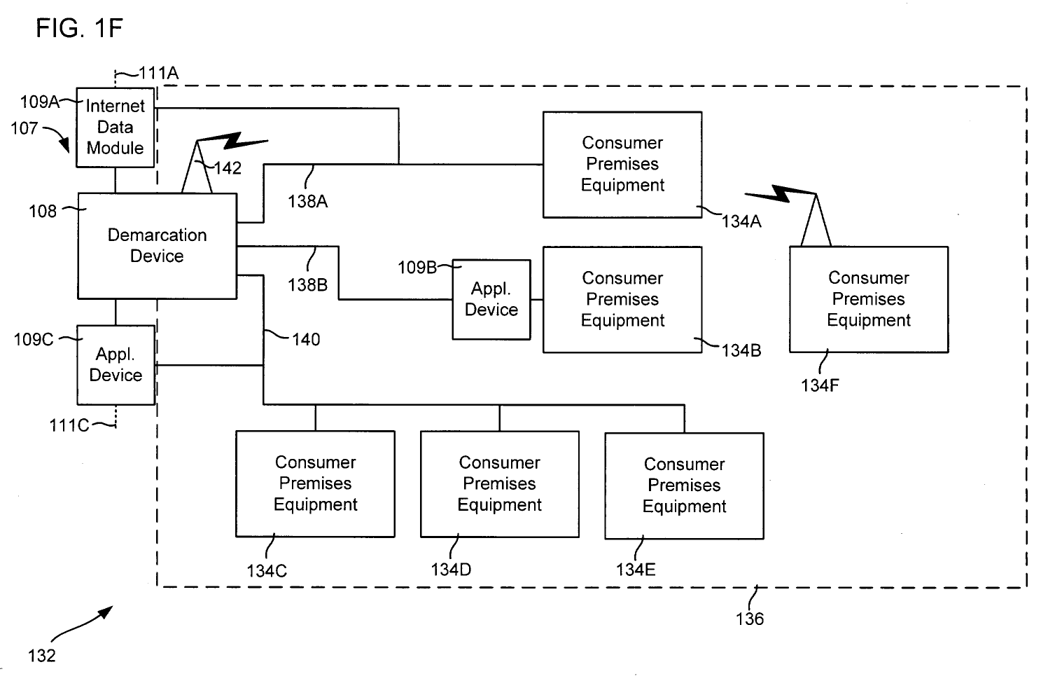

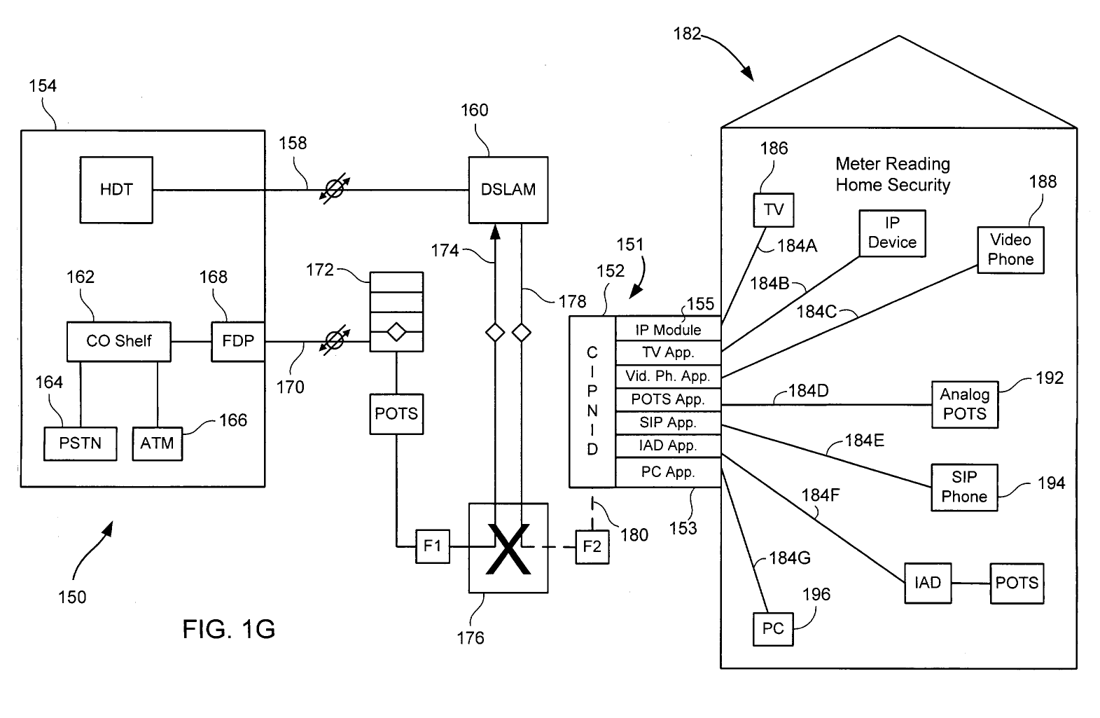

There are numerous organizational configurations that may be used in accordance with embodiments of the invention. Several examples are shown schematically in FIGS. 1A-1G, although such examples are not intended to be exhaustive. A relatively simple arrangement is shown in FIG. 1A, which illustrates a configuration 100 for simultaneously providing internet and television signals using an internet data module. The configuration 100 includes a distribution point 104 in communication with a device 108 having demarcation capabilities via an external transport medium 112. In this example, the external transport medium 112 comprises a transport medium external to a customer premises 116. The device 108 is shown in FIG. 1A as including an internet data module 109 adapted to interface with an internal transport medium 124. In this example, the internal transport medium 124 comprises a transport medium internal to the customer premises 116. While the internal data module 109 is shown as part of the demarcation device 108, this is not a requirement. In other instances, the internet data module 109 may be distinct from, but coupled with, the demarcation device 108, such as by using a modular design with plug-and-play technology. Other examples discussed below illustrate different ways in which the demarcation and internet-data-module devices 108 and 109 may be configured as integrated or separate devices. For convenience, however, the combination of the demarcation 108 device and internet data module 109 is sometimes referred to in a particular embodiment as an “internet-capable network interface device” (“INID”) 107 irrespective of whether they are integrated or separate.

In some embodiments discussed below, an INID may correspond to one of a plurality of “application network interface devices” (“ANIDs”) that may be provided. An ANID corresponds generally to a combination of a network interface device and an application device, of which the internet data module 109 may be considered to be an example. As such, an INID may be considered to correspond specifically to an ANID that includes an internet data module as one of its application devices.

In one sense, the distribution point 104 may be considered to be a source of telecommunication information transmitted to the customer premises and a recipient of telecommunication information transmitted from the customer premises; as described below, however, the distribution point 104 need not be either the ultimate source nor the ultimate recipient of telecommunication information. In certain embodiments, the distribution point 104 may correspond to a telecommunication service provider's local office. In other embodiments, the distribution point may correspond to another network element in the service provider's network, such as a remote termination cabinet and/or a digital subscriber line access multiplier (“DSLAM”). More generally, the distribution point 104 may correspond to any facility operated by a telecommunication service provider that is capable of transmitting telecommunication information to, and/or receiving telecommunication information from, a customer premises 116.

In general, distribution points can be classified, inter alia, as discrete distribution points or complex distribution points. With respect to a particular information set, a discrete distribution point often transmits only the necessary or desired information to the INID 107. In contrast, a complex distribution point can transmit the entire information set to the INID 107. The contrast may be illustrated with regard to video distribution: A discrete distribution point may perform channel switching (at the request of the demarcation device 108), encoding and sending only the desired channel information to the demarcation device 108. In contrast, a complex distribution point might rely upon the demarcation device 108 to perform all channel switching. Those skilled in the art will appreciate that each scheme presents relative advantages and disadvantages.

Distribution point 104 can be capable of transmitting and/or receiving any type of telecommunication information to/from the INID 107, and such telecommunication information can be organized into a plurality of telecommunication information sets, as necessary. For ease of description, FIG. 1A does not show any additional sources or recipients of telecommunication information in communication with distribution point 104, but, those skilled in the art will recognize that, in many embodiments, distribution point 104 can be coupled to multiple customer premises 116 (perhaps via an INID 107 at each customer premises) and often is neither the ultimate source nor the ultimate recipient of telecommunication information. Instead, distribution point 104 usually serves as an intermediary between one or more customer premises 116 and one or more larger telecommunication networks and/or telecommunication information providers, which, as discussed above, can include cable television networks, telephone networks, data networks, and the like. Further, many such networks (as well as, in some embodiments, distribution point 104) can be coupled to the Internet, so that distribution point 104 can serve as a gateway between customer premises 116 and any source and/or recipient of telecommunication information that has a connection to the Internet. The interconnection of telecommunication networks is well known in the art, although it is specifically noted that distribution point 104 can be configured to transmit telecommunication information to (and receive telecommunication information from) virtually any source or recipient of telecommunication information, through either direct or indirect (e.g., through the Internet) communication. Merely by way of example, a distribution point 104 can transmit video signals received from a television programming provider to customer premises equipment, as described in the applications referenced above. In other embodiments, distribution point 104 can be in communication with one or more other customer locations, allowing for private virtual circuits, vlan tags and wavelengths, or rf connections between customer premises 116 and those locations.

In configuration 100, the INID 107 can serve as the interface between external transport medium 112 and customer premises 116. As shown in FIG. 1A, usually both the demarcation device 108 and the 109 comprised by the INID 107 are interfaced with the internal transport medium 124, with the demarcation device interfaced with the external transport medium 112, although other interfacing configurations are also within the scope of the invention. For example, the internet data module 109 may additionally be interfaced with the external transport medium 112. The internet data module 109 may also include a service interface 111 for addressing the internet data module 109. The service interface 111 may comprise a physical interface, such as a universal serial bus (“USB”), FireWire (IEEE 1394), registered jack 11 (“RJ-11”), registered-jack 13 (“RJ-13”), registered-jack 45 (“RJ-45”), serial, coax, or other physical interface known to those of skill in the art. In other embodiments, the service interface 111 may comprise a logical interface, such as may be provided through a logical connection with an IP address.

As conceptually illustrated in FIG. 1A, demarcation device 108 and/or internet data module 109 may be attached to an external wall of the customer premises 116. Such attachment may be performed of an integrated INID 107 or may be performed with the components separately of a separated INID 107. Such a configuration provides many advantages. For instance, if the telecommunication service provider desires to upgrade or otherwise change its network, including, perhaps, external transport medium 112, a technician can perform any necessary changes at demarcation device 108 and/or internet data module 109 as appropriate without entering the customer premises. Coupled with the ability of some demarcation devices 108 to isolate the telecommunication service provider's network from the customer's premises, this can allow the telecommunication service provider to effect substantial changes in it network without impacting or inconveniencing the customer in any respect. This could, for example, allow the telecommunication service provider to upgrade external transmission medium 112 from a copper twisted pair to optical fiber, without requiring any topological changes inside the customer premises 116. Of course, demarcation device 108 and/or internet data module 109 may be located at a variety of alternative locations, and, as previously noted, an INID 107 may also be divided, with different portions situated at different locations, according to the requirements of the implementation.

The internet data module 109 is configured so that it may communicate with CPE 120, which may include both a television device and a computer as described more fully below, and may be located interior to the customer premises through internal transport medium 124. Such communication is used to implement the internet data module 109 functionality with the CPE 120 in accordance with telecommunication information received from the distribution point 104. In addition, the demarcation device 108 may communicate directly with CPE 120 to implement other functions, including functions that may be defined by other applications comprised by the demarcation device 108. While the internal transport medium 124 may comprise any of the media discussed above, in one embodiment it comprises existing wiring in customer premises 116 and, in some embodiments, is capable of carrying voice, data, and video information. For instance, as described in Edward H. Frank and Jack Holloway, “Connecting the Home with a Phone Line Network Chip Set,” IEEE Micro (IEEE, March-April 2000), which is incorporated herein by reference, the Home Phoneline Networking Alliance (“HPNA”) standards allow for simultaneous transmission of both voice information and Ethernet frames across twisted-pair copper telephone wiring. In addition to the transmission of telecommunication information through the INID 107, either directly from the demarcation device 108 or through the internet data module 109, telecommunication information may be transmitted via the reverse path to the distribution point 104. Such telecommunication information received at the distribution point 104 may be transmitted to an information recipient, such as a service provider. For example, such a transmission may be used to send an email message over the internet.

In certain embodiments, the INID 107 can receive state information from a control point 128, which is shown in the illustrated embodiment as associated with distribution point 104. In certain instances, control point 128 can be software and/or hardware operated by a telecommunication service provider for controlling certain features of the operation of the INID 107. For instance, control point 128 can instruct the INID 107 to provide (or cease to provide) particular applications and/or telecommunication services with the internet data module 109 to the customer premises 116. Control point 128 can also provide other directions to the INID 107 through the demarcation device 108, including, for instance, instructions to save or record a particular information set, such that the information set may quickly (and, in some cases), repeatedly be transmitted to customer premises 116.

Often, it may be beneficial to allow the customer to provide state information to the INID 107. Thus, in certain embodiments, control point 128 may have a web interface, such that the customer or any authorized person, such as an employee of the telecommunication service provider or telecommunication information provider, may log onto the web interface and configure options for the INID 107, perhaps resulting in state commands being transmitted from the distribution point 104 to the INID 107. In other embodiments, control point 128 can be a web interface to the INID 107 itself, allowing the customer or other authorized person to configure the INID 107 directly. In still other embodiments, control point 128 can communicate with the INID 107 through an application programming interface (“API”). Hence, in some embodiments, control point 128 can interface with the INID 107 through an API.

In many such embodiments, the API corresponds to the service interface 111 of the application device. In embodiments where the service interface 111 comprises a logical interface, the API can include a set of software, hardware, or firmware routines or libraries that may be invoked programmatically to configure or relay information to the internet data module 109. In that sense, then, control point 128 can be understood to be a program running on a computer, perhaps located at distribution point 104 or customer premises 116, among other locations, that provides state information to the internet data module 109 via a software API.

In other embodiments where the service interface 111 comprises a physical interface such as those described above, the API may be accessed locally, such as by a service technician. For example, the service technician could visit property outside the customer premises 116 or a utility room in an MDU that is external to individual customer premises 116, attach a laptop computer or other device to the physical service interface 111, and upload information to the internet data module 109, including state information and perhaps other telecommunication information. In still other embodiments, the internet data module 109 can accept state information through other means, including, for example, through a web interface by receiving a specially formatted electronic message.

The addressability of the internet data module 109 may be used in various embodiments to change the state of the internet data module 109. Such state information can include any set of data or other information that may be interpreted by the internet data module 109 as defining operational instructions. This includes, for example, commands to process certain information sets in certain ways, e.g., to provide protocol conversion, to allow transmission of the information set, to deny transmission of the information set, to direct transmission on a particular interface, and the like, as well as commands to provide or cease providing a particular service. Thus, in certain aspects, a telecommunication service provider can control the services provided to a customer in several ways. First, the provider can only transmit a telecommunication information set to an INID 107 if the user of that device is authorized to receive that information set. Alternatively, the service provider could send a plurality of information sets to a customer's INID 107, and rely on the state of the component internet data module 109 to determine access to those information sets that are authorized.

Those skilled in the art will appreciate that certain control methods are more well-suited to certain services than to others. For instance, with respect to cable television services, the same set of information may be broadcast to many households, and the INID 107 is well-suited to control access to those services, allowing for greater efficiency in the providing of such services. In contrast, video-on-demand services may instead be controlled at a distribution point 104 or elsewhere such that a particular INID 107 only receives video-on-demand information if the customer already has requested and been authorized to receive that service. In such cases, the INID 107 may not need to provide access control functions with respect to that service.

According to some embodiments, the INID 107 can implement either of these access control schemes, or both in combination, as well as others. Moreover, the INID 107 can, in some cases, be configured to support a plurality of schemes transparently. For instance, the customer could request a service from the INID 107, perhaps using one of the methods discussed above, and the INID 107 could relay that request to the appropriate telecommunication service provider and/or telecommunication information provider, as well as reconfigure itself to allow access to that service, if necessary. Of course, the INID 107 can also be configured to take any necessary validating or authenticating action, such as notifying the distribution point 104 and/or control point 128 that the service has been requested, and, optionally, receiving a return confirmation that the service has been authorized.

In accordance with other embodiments, state information sent to the INID 107 can include one or more commands to interface with a particular CPE in a certain way. State information can further include instructions to modify one or more security settings of the TNID 107. Merely by way of example, in certain embodiments, the INID 107 can include a computer virus scanner, and state information can include updated virus definitions and/or heuristics. Likewise, the INID 107 often will be configured with access controls, such as to prevent unauthorized access through the INID 107 by third parties. State information can include instructions on how to deal with particular third-party attempts to access the INID 107 or internal transport medium 124. Those skilled in the art will recognize as well that some security settings may specify the level of access the customer has to the functions of the INID 107, such as to prevent unauthorized use of certain telecommunication services, and that these settings also may be modified by received state information.

There are a variety of ways in which the various access-control and security functionalities of the INID 107 discussed above may be implemented. In different embodiments, these functionalities may be performed by the demarcation device 108, by the internet data module 109, by a combination of the demarcation and internet data module devices 108 and 109, and/or by still other supplementary application devices that may additionally be comprised by the INID 107. Moreover, the state information that manages such functionalities may sometimes be sent periodically to the INID 107 to ensure that it is current. Those skilled in the art will also recognize that state information can be considered a subset of the broader category of telecommunication information.

Turning now to FIG. 1B, configuration 100′ is illustrative of certain embodiments that can provide multiple ANIDs at customer premises 116, at least of which may be an INID 107A. In the illustrated embodiment, the INID 107A comprises demarcation device 108A and internet data module 109A, and another ANID 107B comprises demarcation device 108B and application device 109B. In some embodiments, ANID 107B may specifically not include an internet data module, so that all internet functions are performed by INID 107A, although more generally ANID 107B could also include an internet data module. In this illustration, the both the internet data module 109A and the other application device 109B are shown as separated from their respective demarcation devices 108, although one or more of the multiple INID or ANID may alternatively comprise structures in which they are integrated. In instances where the components are separated, the separate components may both be affixed to an exterior wall of the customer premises 116. This has the same advantages discussed previously in connection with integrated INIDs, namely ease of upgrading or otherwise changing the network by a telecommunication service provider. In other instances, the separate components may be provided in different locations, such as by providing the demarcation device 108A or 108B at a facility operated by the telecommunication service provider while keeping the internet data module 109A or other application device 109B on the exterior wall of the customer premises 116.

Similar to the configuration of FIG. 1A, internet data module 109A may be in communication with CPE 120A through internal transport medium 124A and other application device 109B may be in communication with CPE 120B through internal transport medium 124B. Implementation of the applications provided by internet data module 109A and application device 109B can thus be achieved respectively with telecommunication information received and transmitted by demarcation devices 108A and 108B. In addition, demarcation device 108A can be in direct communication with CPE 120A through internal transport medium 124A, and demarcation device 108B can likewise be in direct communication with CPE 120B through internal transport medium 124B. Each of the INID 107A and ANID 107B may be provided in communication with a common distribution point 104 through their respective demarcation devices 108. In particular, demarcation device 108B can communicate with distribution point 104 through external transport medium 112B which, as illustrated by FIG. 1B, can simply be spliced into external transport medium 112A, such as by using an active or passive splitting device, which could be optical, as in a fiber environment, or electrical. If desired, demarcation devices 108 and/or distribution point 104 can include control logic to prevent unauthorized access by demarcation device 108A to telecommunication information sent to or received from demarcation device 108B, and vice versa. In other embodiments, external transport medium 112B could run directly from demarcation device 108B to distribution point 104. In still other embodiments, external transport medium 112B could be omitted, with demarcation device 108B coupled to demarcation device 108A, which could then provide connectivity between demarcation device 108B and distribution point 104 through external transport medium 112A.

Configuration 100′ can be used in a variety of implementations. For instance, if customer premises 116 is a multiple-dwelling unit (“MDU”), ANID 107B could comprise an INID by including an internet data module as application device 109B, such that separate INIDs are provided for each separate resident or family. Alternatively, a single demarcation device, perhaps with more interfaces, can service multiple dwelling or business units. In such implementations, especially when external transport medium 112B does not directly couple demarcation device 108B to distribution point 104, demarcation devices 108A, 108B can include security functionality, for example to prevent telecommunication signals intended for CPE 120A from reaching CPE 120B and vice versa. In some embodiments, demarcation devices 108 can provide a variety of such security, encryption, and authentication functions.

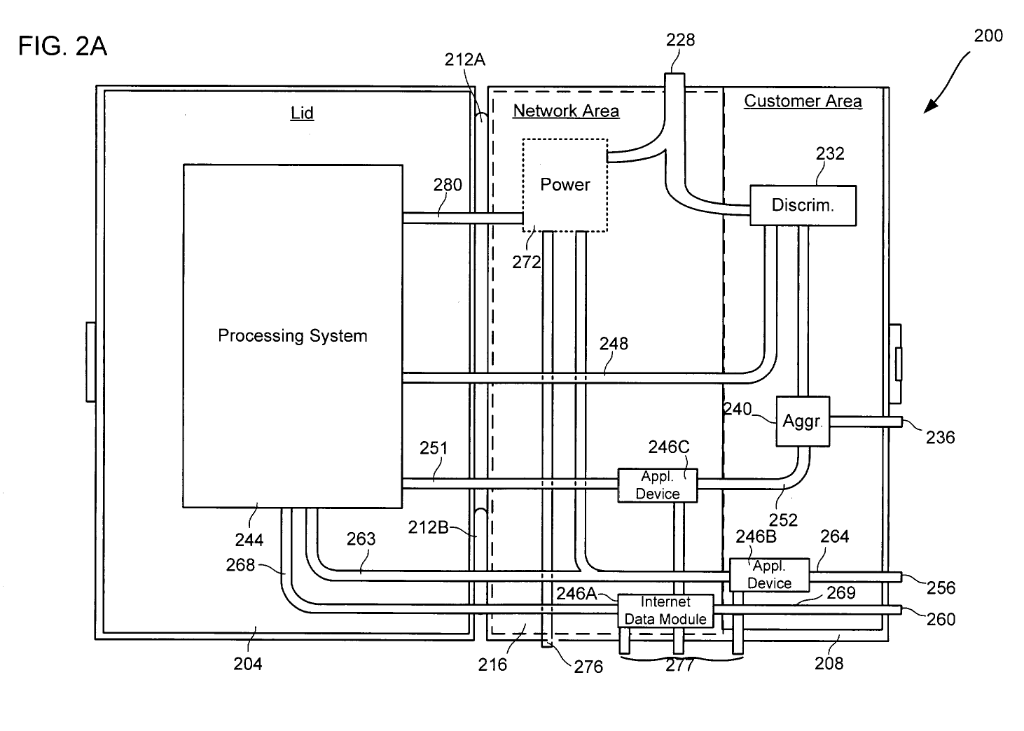

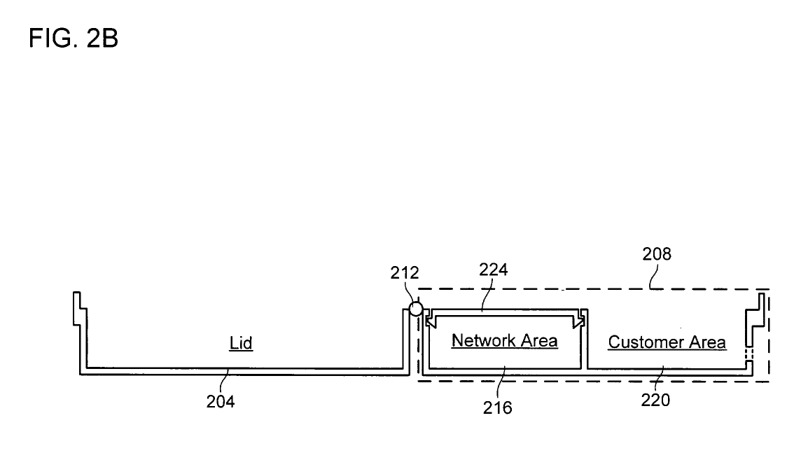

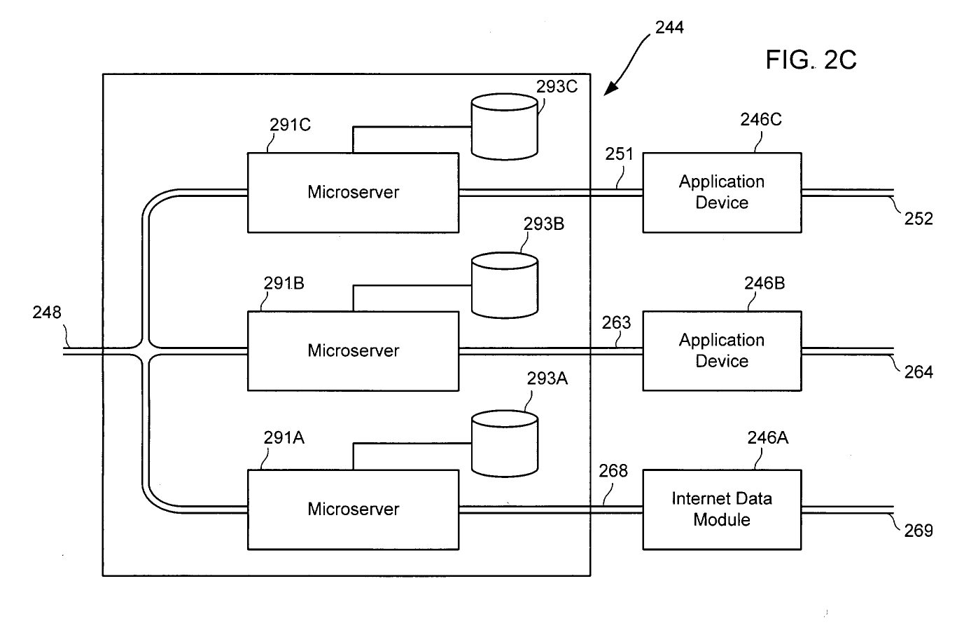

The description above provides a specific example of a more general class of embodiments in which multiple INIDs are daisy-chained together, using any of the telecommunication media discussed herein. This allows a telecommunication service provider to provide service to additional customers without requiring any additional external transport media. Similarly, INIDs at multiple premises can be coupled together, such that if the external transport medium coupled to one of the INIDs fails, that device can maintain connectivity to the distribution point through its connection to another INID. An INID in accordance with specific embodiments thus may have an interface for securely connecting to one or more additional INIDs, and thus forming a mesh network of INIDs and/or distribution points. This allows a particular INID to serve as a conduit between another interface device and a distribution point without allowing any unauthorized reception of telecommunication information intended for the connected interface device. This secure interface can be included, for instance, in a portion of the INID that is inaccessible to customers, as illustrated in FIG. 2A and described below.

In other embodiments, a single customer premises 116 might have connections to a plurality of telecommunication service providers. For example, turning now to FIG. 1C, configuration 100″ includes a distribution point 104A coupled to an INID 107A via external transport medium 112A and also includes a second distribution point 104B coupled to an ANID 107B via external transport medium 112B. INID 107A provides an example of an INID that includes a supplementary application device 109C in addition to the internet data module 109A. Each of these devices 109A and 109C may have a respective service interface 111A and 111C, and may be connected with different internal transport media 124A or 124C to reflect the different application capabilities. Merely by way of example, distribution point 104A could, for example, be associated with an internet service provider, while distribution point 104B could be associated with a cable-television service provider. In addition, configuration 100″ illustrates that multiple CPE 120A and 120C may be coupled with a single INID 107A. This may be done with multiple internal transport media 124A and 124C as illustrated by FIG. 1C, or may alternatively be done through a common internal transport medium as discussed below. In some embodiments, the other application devices 109B and 109C do not comprise an internet data module, but in other embodiments they may. In embodiments where application device 109B comprises an internet data module, ANID 107B thus corresponds to a second INID provided to customer premises 116. In embodiments where application device 109C comprises an internet data module, INID 107A thus corresponds to a multi-internet-data-module INID that may provide separate internet capabilities to different CPE 120A and 120C. Each of these configurations provides a mechanism for providing separate internet capabilities to different CPE within the customer premises, as may be desirable, for example, where different individuals wish to access different parts of the internet simultaneously on different computers.

In another alternative embodiment, such as configuration 100′″ illustrated in FIG. 1D, an INID 107 can provide connectivity to a plurality of distribution points 104A and 104B, as well to a plurality of CPE 120A, 120B, and 120C. In the illustrated configuration 100′″, the INID 107 is provided in a separated form with an internet data module 109A and two other application devices 109B and 109C for providing supplementary application services. The internet data module 109A and one of the other application devices 109B are provided external to the customer premises 116 and have service interfaces 111A and 111B. The second other application device 109C is provided interior to the customer premises, illustrating that it is not a requirement that all of the supplementary application devices comprised by the INID 107 be disposed external to the customer premises 116. In embodiments where one or more of the other application devices, say application device 109B, comprises an internet data module, the INID 107 corresponds to a multi-internet-data-module INID that may provide separate internet capabilities to different CPE 120A and 120B. Furthermore, in some embodiments application device 109C could comprise an internet data module, whereby the overall arrangement comprises internet capabilities not only in the external INID 107, but also comprises one or more internet data modules interior to the premises. The connectivity of a single INID 107 to a plurality of distribution points 104A and 104B and to a plurality of CPE 120A, 120B, and 120C may be effected through attachments for multiple internal transport media 124A, 124B, and 124C and for multiple external transport media 112A and 112B. Moreover, as illustrated by FIG. 1D, each distribution point 104A and 104B may be associated with a different control point 128A and 128B, respectively. In alternative embodiments, a single control point 128 could provide configuration information to the INID 107 with respect to both distribution points 104A and 104B.

Turning now to FIG. 1E, another exemplary configuration 100″″ is presented in accordance with certain embodiments of the invention. In exemplary system 100″″, the INID 107 is shown having a configuration similar to that of FIG. 1D, with a structure in which the demarcation device, internet data module, and other application-device components are separated, including one of the other application devices 109C in the interior of the customer premises 116. Instead of communication of the INID 107 with a plurality of control points 128 being effected through a plurality of distribution points 104, FIG. 1E shows an embodiment in which such communication is achieved with a common distribution point 104. This distribution point 104, which may be operated by a telecommunication service provider, can be in communication with one or more telecommunication information providers 130A and 130B. Each telecommunication information provider 130A and 130B can be the source or recipient of one or more telecommunication information sets, each of which may be associated with a particular telecommunication service. Each of the telecommunication information sets may thus be transmitted to, or received from, the distribution point 104. Distribution point 104 can also transmit these information sets to, or received them from, the INID 107 through demarcation device 108, via external transport medium 112. Such an configuration 100″″ thus exploits a capability of the INID 107 to process a plurality of such information sets in a variety of ways, as discussed below.

In certain embodiments, each telecommunication information provider 130A or 130B may have an individual control point 128B or 128C. In some such embodiments, control points 128B and 128C can be in communication with the INID 107 via distribution point 104 or, alternatively, could have a separate means of communication with the INID 107, such as via a modem and telephone line. Thus, in some embodiments, the INID 107 can receive state information from each control point 128B, and 128C through the demarcation device 108. As discussed above, state information can direct the behavior of the demarcation device 108, internet data module 109A, and/or other application devices 109B and 109C comprised by the INID 107, in particular with respect to how to handle telecommunication information to implement various applications on the CPE 120A, 120B, and/or 120C. Such state information may be received by the INID 107 over the external transport medium 112 or through the service interfaces 111A and 111B of the internet data module 109A and other application device 109B. In some embodiments, the INID 107 can be configured to accept state information related only to the telecommunication information and/or services provided by the telecommunication information provider sending the state information. In this way, the INID 107 can be protected against inadvertent or malicious misconfiguration, which could interrupt a telecommunication service provided by another telecommunication information provider. Likewise, the INID 107 could be configured to automatically request updated state information from control point 128A associated with distribution point 104 in the case of misconfiguration, and control point 128A could maintain a master set of configuration information to be able to accommodate such a request.

In other embodiments, telecommunication information providers 130A and 130B may not have an associated control point. In such embodiments, telecommunication information providers 130A and 130B can send state information to control point 128A, perhaps via distribution point 104A, and control point 128A can relay that state information to the demarcation device 108 (again, perhaps through distribution point 104). In this way the telecommunication service provider can control which state information is transmitted to the INID 107.

In certain embodiments, the demarcation device 108 can submit a request for state information to one or more control points 128A, 128B, and/or 128C, perhaps via distribution point 104. Such a request might be made if, for instance, the customer would like to watch a pay-per-view movie. The appropriate control point, e.g., 128B, could then provide the proper state information to the INID 107 as described above, allowing transmission of the movie to customer premises 116.

As exemplified by configuration 132 in FIG. 1F, embodiments of the invention enable a single INID 107 to serve multiple CPE 134A-F, each of which can comprise a different appliance, at a single customer premises 136. The flexibility provided by the INID 107 may be exemplified in an embodiment where the INID 107 includes other application devices 109B and 109C in addition to the internet data module 109A for providing a variety of supplementary application services. For instance, CPE 134A can be a television, CPE 134B can be a telephone, CPE 134C can be a video game system, CPE 134D can be a computer with an Ethernet interface, CPE 134E can be a computer with an HPNA interface, and CPE 134F can be a laptop computer equipped with a wireless network card. The user functionality of each of these CPE examples may be enhanced with the internet data module 109A and other application devices 109B and 109C comprised by the INID 107.

Also as illustrated by configuration 132, the single INID 107 can support multiple network topologies. For instance, the INID 107 can serve as a hub for a point-to-point network topology, with multiple point-to-point connections to CPE 134A and 134B via internal transport media 138A and 138B, respectively. In addition, the INID 107 can support a bus topology, as illustrated by internal transport medium 140, which can connect the INID 107 to CPE 134C, 134D, and 134E. The INID 107 can also be equipped with a wireless transmitter 142 for communication with wireless-capable CPE 134F. In this way, the INID 107 can support a wide variety of networking media in customer premises 136, including the existing telephone, satellite, cable, and network wiring. For instance, the existing telephone wiring in most homes is arranged in a bus topology, as is most coaxial cable (for instance RG6 or RG59) installed by cable television providers, although each may, in some implementations, be wired using a star topology. In contrast, many homes also have 10Base-T Ethernet networks, which sometimes require a central hub. As used herein, the term “10Base-T” can be understood to include newer implementations of Ethernet over unshielded twisted pair wiring, including, for instance, 100 megabit Ethernet (100Base-T, 100VG-AnyLAN, etc.) and gigabit Ethernet (1000Base-T) standards. The INID 107 can support these and other network topologies, serving as the hub in a 10Base-T network if necessary.

FIG. 1G illustrates another exemplary configuration 150 for using an INID 151 in an xDSL implementation, according to certain embodiments of the invention. In some embodiments, distribution point 154 can comprise a host digital terminal 156 coupled by transport medium 158 to DSLAM 160. As noted above, however, in other embodiments, DSLAM 160 can be considered the distribution point. Host digital terminal 156 can be coupled to any of a variety of data sources and/or recipients, either directly, or indirectly, such as through the provider's network and/or the Internet. In the illustrated embodiment, transport medium 158 can be a Synchronous Optical NETwork (“SONET”) link (e.g., OC-3, OC-12, etc.), although those skilled in the art will recognize that other suitable transport media may be substituted.

In accordance with some embodiments, distribution point 154 also comprises a central office shelf 162 in communication with the PSTN 164, as well with an asynchronous transfer mode (“ATM”) network 166, either of which can provide connectivity to any of the variety of data sources and/or recipients discussed above. In certain embodiments, shelf 162 is, in turn, coupled to fiber distribution panel 168, which is connected by transport medium 170 to a digital loop carrier remote termination cabinet 172. Remote termination cabinet 172 can also be coupled to DSLAM 160 by transport medium 174, which may be routed through serving area interface 176. In effect, transport medium 174 can carry one or more POTS information sets, and transport medium 158 can carry one or more non-POTS (in this case xDSL) information sets.

As illustrated, these two information sets can be combined at DSLAM 160, which is in communication with serving area interface 176 through transport medium 178. Serving area interface 176 can be coupled to demarcation device 152 of INID 151 with transport medium 180. In addition to the demarcation device 152, the INID 151 comprises an internet data module 155 and a plurality of other application devices 153, the combination being adapted to provide internet and other application functions to various equipment within the customer premises 182. In the illustrated embodiment, the INID 151 is fixedly attached to an exterior wall at the customer premises 182. The internet data module 155 and other application devices 153 of the INID 151 may then be coupled via one or more internal transport media 184A-G to a variety of CPE, including without limitation a television set 186, a video phone 188, an analog (POTS) telephone 192, an IP-compatible phone 194, and a personal computer 196. In this way, an INID 151 can be used to provide a plurality of telecommunication services to a customer premises, including internet functions.

2. Structure of an Internet Network Interface Device

One exemplary embodiment of an INID 200 is illustrated in FIGS. 2A and 2B. For purposes of illustration, FIG. 2A provides a top view that explicitly shows components within the INID 200, while FIG. 2B provides a side view that shows the logical organization of the INID 200 without the components. In the illustrated embodiment, INID 200 comprises a clamshell design, with a lid portion 204 and a body portion 208 connected by hinges 212A and 212B. The body portion 208 comprises a network area 216 and a customer area 220. Generally, network area 216 is adapted to receive a cover and is designed generally to be accessible only to personnel authorized by the telecommunication service provider. In contrast, when INID 200 is open, the customer can access customer area 220 to add or remove components as desired. In this and other ways, the INID 200 serves to isolate the telecommunication service provider's network from the customer's network, as described above.

The INID 200 can include a first interface 228 for communicating with the provider's external transport medium. Those skilled in the art will recognize that, in some embodiments, as described above, the external transport medium may comprise the twisted-pair copper “local loop” running from the customer's premises to the telecommunication service provider's local office, and interface 228 will allow for the attachment of the local loop to the INID 200. As discussed above, in other embodiments, the external transport medium can be any of a variety of other media, including satellite transmissions, wireless transmissions, coaxial cable, and the like. In fact, in certain embodiments, the external transport medium can comprise multiple transport media (of the same or different types), for which the INID 200 could include multiple interfaces. In some such embodiments, the INID 200 can function to couple a plurality of external transport media to one another, seamlessly increasing the bandwidth available to the customer premises. For instance, a customer premises might have a satellite link to one telecommunication service provider and an ADSL link to another provider, and the INID 200 could combine or multiplex these two links to provide an apparent single, higher-bandwidth to the customer premises. Similarly, those skilled in the art will recognize that in certain of these embodiments, a particular external transport medium, such as a satellite link, may be more well-suited to one way transmission of telecommunication information; in such cases, the INID 200 could use a second external transport medium, such as an ADSL link, to allow transmission in the other direction.

Interface 228 can be coupled to a discrimination device 232, which can be operative to separate information sets received on interface 228, and, conversely, aggregate information sets for transmission on interface 22). Merely by way of example, in particular embodiments, discrimination device 232 can separate POTS information from other telecommunication information and/or isolate signals on the internal transport medium from the external transport medium and vice versa. In some embodiments, for instance xDSL implementations, discrimination device 232 can comprise one or more filters. Such filters can include, but are not limited to, high-pass, low-pass, and/or band-pass filters. For instance, in an xDSL implementation, discrimination device 232 might include a high-pass and/or low-pass filter for separating high-frequency (e.g., data) from low frequency (e.g., POTS) information. In other embodiments, discrimination device 232 can comprise many other types of filters, including both digital and analog filters. Discrimination device 232 can be operable to separate information sets through a variety of criteria, including for example, by frequency, by destination device, information type, and/or frequency. Further, in certain embodiments, information sets can be multiplexed (for instance, using various time-division multiplexing or wave-division multiplexing schemes known in the art) for transmission over an external transport medium, and discrimination device 232 can comprise a demultiplexer capable of separating multiplexed signals and, optionally, routing each signal to the necessary destination.

In the illustrated embodiment, discrimination device 232 is in communication with a second interface 236, which can interface with the telephone wires at the customer premises to provide traditional analog telephone service. In some embodiments, an aggregator 240 can be situated between discrimination device 232 and interface 236 to allow additional, perhaps non-POTS, information sets to be sent and received through interface 236 simultaneously with the POTS information. This can include, for example, aggregating information sets for transmission of an HPNA signal over an internal transport medium.

The discrimination device can also be coupled to a processing system 244, which in the illustrated embodiment is located in the lid portion 204, and all non-POTS information sets can be routed to processing system 244 for additional processing. Processing system 244 is described in detail below, but can, in general, comprise one or microprocessors, including digital signal processor (“DSP”) chips, memory devices, including both volatile and nonvolatile memories, and storage devices, including hard disk drives, optical drives and other media. In fact, processing system 244 can comprise the equivalent of one or more personal computers, running any of a variety of operating systems, including variants of Microsoft's Windows™ operating system, as well as various flavors of the UNI™ operating system, including open source implementations such as the several Linux™ and FreeBS™ operating systems.

Telecommunication information or information sets can be processed by processing system 244 in a variety of ways, including, for example, routing a given information set to a particular interface, transforming information such as by encoding and/or decoding information and converting between different transport protocols, storing information, filtering information, and any of the other functions described herein with respect to processing systems. In certain embodiments, processing system 244 can serve as the termination point for an external transport medium; for instance processing system 244 can incorporate the functionality of an xDSL modem. In other embodiments, processing system 244 can serve to identify quality-of-service requirements (for instance, latency requirements for voice transmissions and bandwidth requirements for streaming media transmissions, to name a few) and enforce those requirements, ensuring that sufficient bandwidth is provided to a particular device, network segment or application to maintain the quality of service required.

In certain embodiments, such as those described above with respect to FIG. 1D, an INID may comprise another interface in communication with a second distribution point 104B through an additional external transport medium 112A, perhaps operated by a different telecommunication service provider. In such a case, the additional external interface could be coupled to discrimination device 232, or it could be coupled to another discrimination device, which could also be in communication with processing system 244, interface 236 and/or aggregator 240. Thus, certain embodiments allow a single INID to serve as a communication gateway between the customer premises and multiple telecommunication service providers, including combining or multiplexing multiple external transport media (each of which may be in communication with a different telecommunication service provider and/or telecommunication information provider) as discussed above.

In the illustrated example, processing system 244 is in communication with aggregator 240, which, as discussed above, can aggregate non-POTS information sets received from processing system 244 and POTS information sets received directly from discrimination device 232 for consolidated transmission via interface 236. In effect, discrimination device 232 and aggregator 240, perhaps in conjunction with processing system 244, can function to separate telecommunication information received on interface 228 into a set of POTS telecommunication information and a set of non-POTS telecommunication information. POTS information can be understood to include ordinary telephone signals, and non-POTS information can be understood to include all other telecommunication information). The non-POTS information is routed via transport medium 248 to processing system 244 for processing, and the POTS information is routed to interface 236 for transmission to the internal transport medium. In certain embodiments, one or more sets of non-POTS information can be routed to interface 236 using transport medium 252 for transmission through interface 236, perhaps in combination with one or more sets of POTS information.

Of course, discrimination device 232 and aggregator 240 can perform the same function in reverse, i.e., to separate and recombine different sets of telecommunication information received on interface 236 from the customer's premises. Thus, in some embodiments, both discrimination device 232 and aggregator 240 each can perform a combined discrimination-device-aggregator function, depending on the direction of information flow. In fact, while termed “discrimination device” and “aggregator” for ease of description, those two devices can actually be identical, and further, their functionality can, in some embodiments, be incorporated into a single device, which could be coupled to interface 228, interface 236, and processing system 244, and could route information sets among any of those three components as necessary. Moreover, as described below, the functionality of discrimination device 232 and/or aggregator 240 can be incorporated into processing system 244; likewise discrimination device 232 can incorporate interface 228 and/or aggregator 240 can incorporate interface 236, such that discrimination device 232 and/or aggregator 240 comprise the necessary components to be coupled directly to the external and internal transport media, respectively.

Discrimination device 232 and/or aggregator 240 can also serve another function in certain embodiments: Since the external transport medium is coupled to first interface 228 and the internal transport medium can be coupled to, inter alia, second interface 236, the discrimination device 232 and/or aggregator 240 can serve as an isolation device for intermediating between the two media, such that when a topological change occurs in one of the media, only the INID interface need be changed, and the other transport medium is not affected. In some such embodiments, discrimination device 232 and/or aggregator 240 can serve to intermediate (including protocol translation and the like) between interfaces 232, 240, allowing either the internal or the external transport medium to be upgraded or changed without impacting the other transport medium. Of course, in certain embodiments, this isolation function also could be performed by processing system 244. In yet other embodiments, the isolation device might comprise a separate piece of hardware in communication with discrimination device 232, aggregator 240 and/or processing system 244.

In order to effect the internet functionality, the INID 200 comprises an internet data module 246A, and may also comprise one or more other application devices 246B and 246C to implement supplementary applications. The internet data module 246A and other application devices are usually disposed in the network area 216, but as illustrated for other application device 246B, they may sometimes be disposed in the customer area 208 to permit access by the customer. The internet data module 246A is provided in communication with the processing system 244 by transport medium 268. The other application devices 246B and 246C may also be provided in communication with the processing system 244 by transport media 251 and 263. The internet data module 246A is also in communication with interface 260 over transport medium 269, which allows communication with the transport media internal to the customer premises. For example, interface 260 could be a coaxial interface for connection to RG6 and/or RG59 cable. Similar communication with the transport media internal to the customer premises may also be provided in some embodiments for application devices providing supplementary services. Such an example is illustrated with other application device 246B in communication with interface 256 over transport medium 264. Merely by way of example, interface 256 could be an RJ45 and/or RJ11 interface for connection to unshielded twisted pair cable, which can, for instance, form a 10Base-T Ethernet network.

To illustrate, in one application the internet data module 246A is used to overlay a video stream onto an analog signal so that the internet data may be viewed simultaneously with the analog data at a television, such as with a PIP capability. Thus, if interface 228 receives telecommunication information that includes digitally encoded video signals, such as MPEG-2 data, the information set that includes the encoded video signals can be routed by discrimination device 232 to processing system 244. After transmission from the processing system to the internet data module 246A over transport medium 268, the signals can be decoded into RF-modulated NTSC, HDTV, PAL and/or SECAM format for transmission via transport medium 269 to coaxial interface 260. These formatted signals may then be overlaid over the analog video stream and transmitted via coaxial cable to one or more televisions at the customer premises.

For other supplementary applications, such as illustrated with other application device 246C, information might be routed from the application device 246C through the aggregator 240. Such an arrangement may be suitable for supplementary applications that use IP data, such as a VoIP application. For example, the INID 200 might receive IP data combined with television information and perhaps also other types of telecommunication information, on interface 228. The information sets can be routed by the discrimination device 232 via medium 248 to processing system 244, where they can be processed. Television information could then be routed via transport medium 263 to a set-top-box device 246B for subsequent delivery of that information through interface 260 in accordance with the level of service subscribed for by the customer. Simultaneous implementation of such set-top-box functionality with other applications is described in copending, commonly assigned U.S. patent application Ser. No. ______ entitled “METHODS AND SYSTEMS FOR PROVIDING TELEVISION SIGNALS USING A NETWORK INTERFACE DEVICE,” filed May 22, 2003 by Bruce A. Phillips et al. (Attorney Docket No. 020366-089400US), the entire disclosure of which is incorporated herein by reference for all purposes. For example, premium television channels may or may not be decoded by the set-top-box device 246A and pay-per-view programming may or may not be transmitted by the set-top-box device 246A depending on the service level.

Similar types of routing and processing may be performed for other supplementary applications as well. It will be appreciated that it many instances the supplementary applications act to enhance the functionality provided by the internet data module 246A. In other instances, the supplementary applications provide functionality in the customer premises that is not directly related to the internet-data-module 246A functions, but which is conveniently coordinated by the INID 200. For instance, if other application device 246C comprises a VoIP application device, the corresponding IP data information set received at the processing system 244 could be extracted and routed to other application device 246C over transport medium 251. It may then be provided to the customer's existing telephone wiring using interface 236, optionally in conjunction with aggregator 240 and/or one or more line drivers. In this way, the INID can allow virtually unlimited connectivity options for each CPE at the customer premises, in addition to providing the internet-data-module functionality. Adding to the flexibility of INID 200, the processing system 244 could include components to serve, for example, as a cable or xDSL modem, as well as components to serve as an Ethernet hub, switch, router, or gateway, the functions of each of which are familiar to those of skill in the art.

There are a variety of different other application devices 246B and 246C that may be incorporated within the INID 200 in order to provide a versatile range of supplementary functionality. The following examples are provided merely by way of illustration and still other application devices that may additionally or alternatively be used will be evident to those of skill in the art after reading this description. One supplementary application device 246B or 246C that may be included is a digital-recorder application device, which could provide a mechanism for digital recording of all forms of information incoming to the INID 200 and make them accessible to a user at the customer premises. The information that could be recorded includes video, data, voice, among other types of information. Another supplementary application device 246B or 246C that may be included is a digital storage application device, which could provide a supplementary mechanism for storing information presented to user applications. The information that could be stored also includes video, data, voice, and other types of information. The combination of a digital-recorder application device and a digital-storage application device in an INID 200 may be used conveniently to provide primary and secondary information-storage capabilities. For example, a digital-recorder application could be used to provide a primary, on-line, video storage capability while a digital-storage application could be used to provide a secondary, off-line, video storage capability. Still other supplementary application devices could be included to enhance such functionality further, such as a hard-drive application device to permit expandable storage capabilities.

Other examples of supplementary application devices 246B or 246C whose functions may be conveniently coordinated include digital-asset application devices. For example, one of the other application devices 246B or 246C in the INID 200 could comprise a digital-asset sharing application device to permit sharing of information among equipment within the customer premises. Such an asset-sharing capability may be used within the customer premises to share video, data, electronic books, games, music, and the like. Another of the other application devices 246B or 246C could comprise a digital-asset caching application device to permit storage and distribution of digital assets. The combination of digital-asset sharing application devices and digital-asset caching application devices among a plurality of INIDs 200 in a service are could then be used to permit exchange of video, data, electronic books, games, music, and the like among customer premises throughout a defined service area. In some instances, a further supplementary application device 246B or 246C could comprise a digital-asset protection application device to control the distribution of digital assets in accordance with legal restrictions, such as those derived from copyright ownership.

In some embodiments, the other application devices 246B or 246C may comprise application devices for effecting various voice-related applications within a customer premises. For example, a voice application device could include functionality to provide such functions as telephone caller identification, call logs, voice mail-storage, voice-mail retrieval, call waiting, solicitation barriers, and the like. In addition, a VoIP application device could provide support for VoIP functions within the customer premises.

Still further supplementary application devices 246B or 246C that may be used include various types of informational applications. For example, an online digital guide application device could be used to provide a digital data guide for television, music, and other types of programming. Such a data guide could be provided alternatively in real time or in non-real-time. A further example of an informational application could be realized with a home-utilities application device adapted to provide monitoring and/or billing tracking functions for utilities used within the customer premises. In this way, the use and/or cost of electricity, gas, water, and other utilities may be monitored by the customer. In addition, a diagnostic-interface application device may be provided to permit diagnostic functions of equipment within the customer premises, thereby permitting the customer to obtain information on the functioning of such equipment.

Other application devices 246 may provide security functions. For example, a data security application device may be used to provide hacker protection for the home, responding to identified attempts to breach the security of the customer premises. In addition, a home-security application device could be provided to monitor the physical security of the customer premises. Such a home-security application device would typically be provided with an interface to door and window monitors to determine whether they are open or shut, and with an interface to motion detectors, glass-breaking detectors, and other physical security equipment known to those of skill in the art.

The internet data module 246A and each of the supplementary application devices 246B or 246C in the INID may include a service interface 277 to permit their states to be changed and/or updated. As previously noted, such interfaces may comprise physical interfaces such as USB, FireWire (IEEE 1394), RJ-11, RJ-45, serial, coaxial, or other physical interfaces, to permit a service technician to interact with the internet data module 246A or supplementary application devices 246B or 246C while at the site of the INID 200. Alternatively, the service interfaces may comprise logical interfaces to permit IP addressing to be used in changing the state of the application devices. In many instances, the INID 200 may also include a future-application device with open architecture to support new applications. The architecture may be configured by use of the service interfaces 277 when the new application is implemented.

In certain embodiments, INID 200 can comprise a line driver (not shown on FIG. 2A or 2B), coupled to processing system 244 and aggregator 240. The line driver can function to allow conversion between various network formats and media, allowing a variety of different media types, e.g., twisted pair and/or coaxial cable, in accordance with the HPNA and HPNA+standards, as well, perhaps, as the customer premises' A/C wiring, in accordance, for example, with the HomePlug™ standard, to transport combined POTS and non-POTS information sets.

In certain embodiments, INID 200 can comprise a power supply 272 for providing electrical power to the components in INID 200. Power supply 272 can be powered through electrical current carried on the external transport medium and received on interface 228. Alternatively, power supply can receive electrical current from a coaxial interface, such as interface 256, or through a dedicated transformer plugged into an AC outlet at customer premises, e.g., through 12V connection 276. Processing system 244 can be powered by a connection 280 to power supply 272, or through one or more separate power sources, including perhaps the A/C power of the customer premises. In some embodiments, processing system 244 might have its own power supply.

As mentioned above, processing system 244 can comprise a plurality of processing devices, and each processing device can comprise multiple components, including microservers, memory devices, storage devices and the like. As used herein, a “microserver” is intended to refer to any device programmed to perform a specified limited set of functions, such as an EPROM. Merely by way of example, FIG. 2C provides a detailed illustration of an exemplary processing system 244, which comprises multiple processing devices 291. In accordance with the exemplified embodiment, transport medium 248 links processing system 244 with an external transport medium, perhaps via a discrimination device and/or interface, as described above.

Transport medium 248 can be coupled to a plurality of microservers 291 such that any information received by the processing system 244 via transport medium 248 may be routed to any of the microservers 291. Each microserver can, in some embodiments, be the equivalent of a server computer, complete with memory devices, storage devices, and the like, each of which is known in the art. In FIG. 2C, storage devices 293 associated with each of the microservers 291 are shown. One of the microservers 291A may be associated with the internet data module 246A and each of the other microservers 291B and 291C may be associated with a respective one of the supplementary application devices 246B or 246C. The supplementary microservers 291B and 291C may individually be adapted to function as, for example, HTML microservers, authentication microservers, FTP microservers, TFTP microservers, DHCP microservers, WebServer microservers, email microservers, critical alert microservers, home-security microservers, VPN microservers, advertising microservers, instant-messaging microservers, wireless microservers, rf microservers, test-access microservers, data-security microservers, and the like.

In addition to these functions, microservers 291 can be configured to route information sets received via transport medium 248, according to the type of telecommunication information in the set (e.g., encoded video, IP data, etc.) as well as any addressing information associated with either the set or the information it comprises (e.g., a specified destination port or network address for a particular subset of telecommunication information). In this way, microservers 291 can serve switching functions somewhat similar to that described with respect to discrimination device 232 described in relation to FIG. 2A. For instance, if IP-signal data is received by microserver 291A, such data can be routed to the internet data module 246A for transmission as appropriate according to embodiments of the invention. As an example of a supplementary application, if television-signal data is received by microserver 291B, such data can be routed to a set-top-box within the INID for decoding and transmission to a television set within the customer premises. In fact, in certain embodiments, processing system 244, and in particular one or more of microservers 291, can incorporate the functionality of discrimination device 232 and/or aggregator 240, rendering those components optional. In some embodiments, one or more of the microservers may be adapted to function as a controller for the INID 200, overseeing the INID's state and monitoring performance. In some embodiments, the controller functions can be accessed using a web browser.

Processing system 244 can have multiple means of input and output. Merely by way of example, microservers 296 can communicate with one or more external transport media (perhaps, as discussed above, via intermediary devices) using one or more transport media (e.g., 248). Processing system 244 also can communicate with one or more internal transport media via a variety of information conduits, such as category 5, 5e and/or 6 unshielded twisted pair wire 268, RG6 and/or RG59 coaxial cable 264, and category 3 unshielded twisted pair copper (telephone) wire 252, again possibly via intermediary devices, as discussed with reference to FIG. 2A. Notably, some embodiments of processing system 244 can include interfaces for multiple transport media of a particular type, for instance, if processing system 244 serves as a networking hub, switch or router. Processing system 244 can also have infra-red and radio-frequency receivers and transmitters, for instance to allow use of a remote control device, as well as wireless transceivers, for instance to allow wireless (e.g., IEEE 802.11) networking.

3. Simultaneous Delivery of Computer Data Stream to Multiple Consumer Equipment

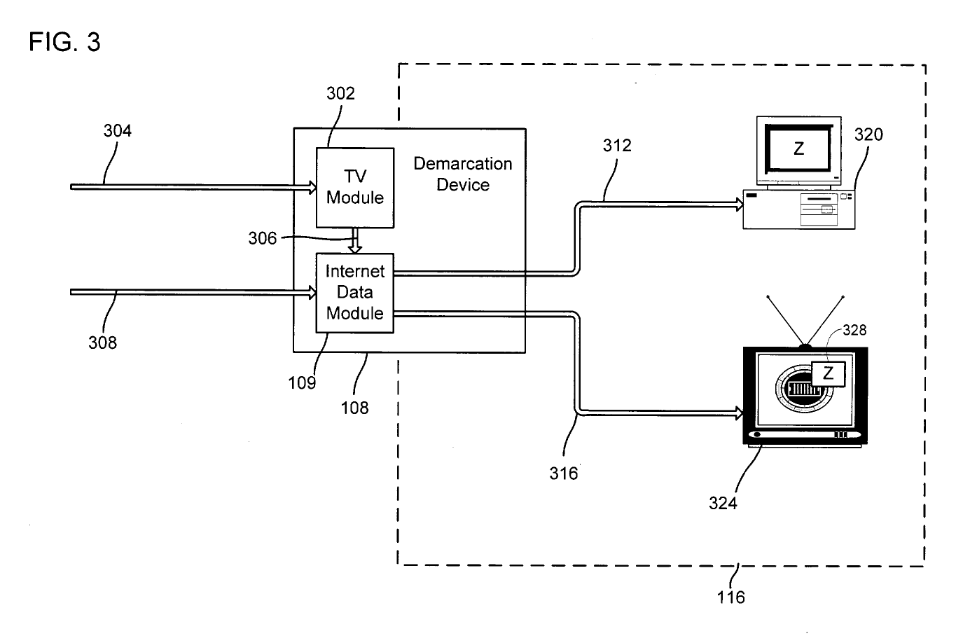

According to embodiments of the invention, a computer data stream may be delivered by the INID simultaneously to a computational device within the customer premises that has requested the data stream, and to another video appliance within the customer premises. Advantageously, in some embodiments, the computer data stream may be overlaid onto a television-signal stream so that the computer data stream may be viewed simultaneously on the video appliance with the television-signal stream. A general overview of the structure that is provided with the INID in such embodiments is provided in FIG. 3. In this figure, the video appliance is shown as a television set 324 having PIP capability, although such capability is not required in all embodiments. In alternative embodiments, different video appliances may alternatively be used, including, for example, video appliances having split-screen capability. Also, the computational device is illustrated in the form of a personal computer 320, although more generally any computational device may be used, including laptops, personal digital assistants (“PDAs”), and the like.

The INID comprises a demarcation device 108, an internet data module 109, and a TV module 302. The TV module 302 may take a variety of different forms in different embodiments. In one embodiment, it advantageously comprises a set-top box, which permits a variety of supplementary functions to be provided in concert with the delivery of the computer data stream, such as premium-channel, pay-per-view, and similar services. Alternatively, the TV module 302 could comprise a simple cable decoder, or could even comprise a mere antenna equipped to receive airwave transmissions. In any event, the TV module 302 is equipped to receive a television signal 304 and to provide a converted television signal 306 to the internet data module 109. In addition to receiving the converted television signal 306, the internet data module 109 is equipped to receive a computer data stream 308, often in response to a request for a particular data stream originating within the consumer premises 116.

The internet data module 109 may have a plurality of outputs, one of which provides the computer data stream 308 in substantially unchanged form to the computational device 320 as signal 312. The other output provides an overlaid signal 316 that includes both the computer data stream 308 and the converted television signal 306. In combining the computer data stream 308 with the converted television signal 306, the internet data module 109 may assign the computer data stream to a channel unused by the converted television signal 306 or may provide the computer data stream as a substitute for a specified channel. For example, where a user never watches a particular channel because its content is provided in a foreign language or is not of any interest to the user, that channel may be substituted by the internet data module 109 with the computer data stream 308.

The combined signal 316 is provided to the video appliance 324, such as over internal coaxial cable lines within the customer premises 116. The computer data stream 308 is assigned by the internet data module 109 to a particular channel, enabling the video appliance 324 to tune to the computer data stream 308 as desired. In some embodiments, the internet data module 109 may be configured to provide a plurality of computer data streams 308 that are otherwise directed to respective computational devices 320 on the combined signal 316. In such instances, the video appliance 324 could selectively display a selected one of the plurality of computer data streams 308 by tuning to the channel corresponding to the selected computer data stream 308.

A number of applications may be realized by such an arrangement. Some examples of such applications are presented herein to illustrate the versatility of he arrangement, but further applications will be evident to those of skill in the art. For example, in an embodiment where the video appliance 324 is configured only to display a single channel tuned from an input having a plurality of channels, it may be used selectively to tune to any of the television video signals originating from signal 304 or to tune to the computer data stream 308. A television without capability is an example of such a video appliance. Thus, with such a configuration, an individual watching a television program on the video appliance 324 could periodically change the channel, such as during a commercial break, to view the content being transmitted to one of the computational devices 320. Where the internet data module 109 is configured to provide computer data streams 308 corresponding to those being provided to a plurality of computational devices 320 onto the combined signal 316, the individual may monitor each of the computer data streams. For instance, the individual might tune to channel 68 to view the computer data stream being transmitted to a first computational device 320 and tune to channel 69 to view the computer data stream being transmitted to a second computational device 320.

In an embodiment where the video appliance 324 is configured to display multiple channels simultaneously, such as by using a PIP function shown schematically in FIG. 3, the display may include any of the channels selected from the combined signal 316. For example, the main display on the video appliance 324 could be tuned to one of the television video signals originating from signal 304 while the embedded picture 328 is used to display one of the computer data streams 308. In instances where a plurality of computer data streams 308 are comprised by the combined signal 316, the viewer of the video appliance 324 has the additional flexibility to change the content of the embedded picture 328 by retuning. Moreover, the flexibility of the arrangement additionally permits the viewer to tune the main picture of the video appliance 324 to one of the computer data streams 308 as desired. Also, since either the main picture or the embedded picture may be tuned to any of the channels on the combined signal 316, a viewer may arrange to have two computational data streams 308 displayed at the same time, perhaps corresponding to data streams being transmitted to different computational devices 320 within the customer premises 116. In still other embodiments where the video appliance 324 is provided with the capacity to display more than two images simultaneously, any combination of signals chosen by the view may be displayed, including zero or more television signals 304 and zero or more computer data streams 308.

Irrespective of the specific capabilities of the video appliance 324, the flexibility of the viewer to select any desired combination of signals according to the number of possible simultaneous displays permits a variety of applications. For example, one of the computer data streams 308 may comprise any information available from the Internet as accessed by the internet data module 109. Such information could include, for example, sporting events, movies, music videos, and/or any other digital media. The ability to access such information directly from the Internet in this fashion avoids restrictions placed on the external television-signal content by an external service provider according to timetable, geographic, or other restrictions. In another embodiment, stock-market monitoring may be accessible for display by the video appliance 324 by having the internet data module 109 request data from a stock-market web site over the Internet. In a further embodiment, TV guide information may be accessible to the video appliance 324 on one of the channels of the combined signal 316 by having the internet data module 109 connect to a TV guide web site; when the video appliance 324 includes PIP or other multidisplay capability, it is thus possible for a viewer to change the channel of a program while maintaining a view of the TV guide information. The scope of content that may be displayed on the video appliance 324 in accordance with embodiments of the invention is as diverse as the scope of information accessible by the internet data module 109.

For example, in other embodiments, the arrangement may serve as an electronic-mail monitoring system. By having the internet data module 109 connected to an electronic-mail site, a change in the display of the video appliance 324 on the corresponding channel, and as may be provided in the embedded PIP display 328, may indicate the arrival of new messages that may themselves then conveniently be viewed on the video appliance 324.

In one embodiment, display of a data stream that is also being transmitted to one or more of the computational devices 320 may be used to monitor internet-access activity originating on the computational device 320, which may be located elsewhere within a home. This may advantageously be used as part of a parental monitoring function, such as when a parent watching programming on the video appliance 324 may simultaneously see what activity is taking place on a computational device 320 being used by a child. In embodiments where multiple children have access to different computational devices 320, the ability of the internet data module 109 to provide separate channels for data streams 308 transmitted to each of the computational devices 320 permits a parent to switch conveniently back and forth among displays from the different computational devices 320 by tuning the video appliance 324.

It is noted that the arrangement shown in FIG. 3 also permits use of the video appliance 324 without display of computer data streams 308 in instances where that is desired. For example, if one parent in a home wishes to watch television programming and the other separately wishes to view material over the Internet, each may perform those activities unimpeded by the activities of the other. The computational device 320 may still receive the computer data stream 308 from the internet data module 109 while the video appliance 116 may still be tuned to the desired programming.

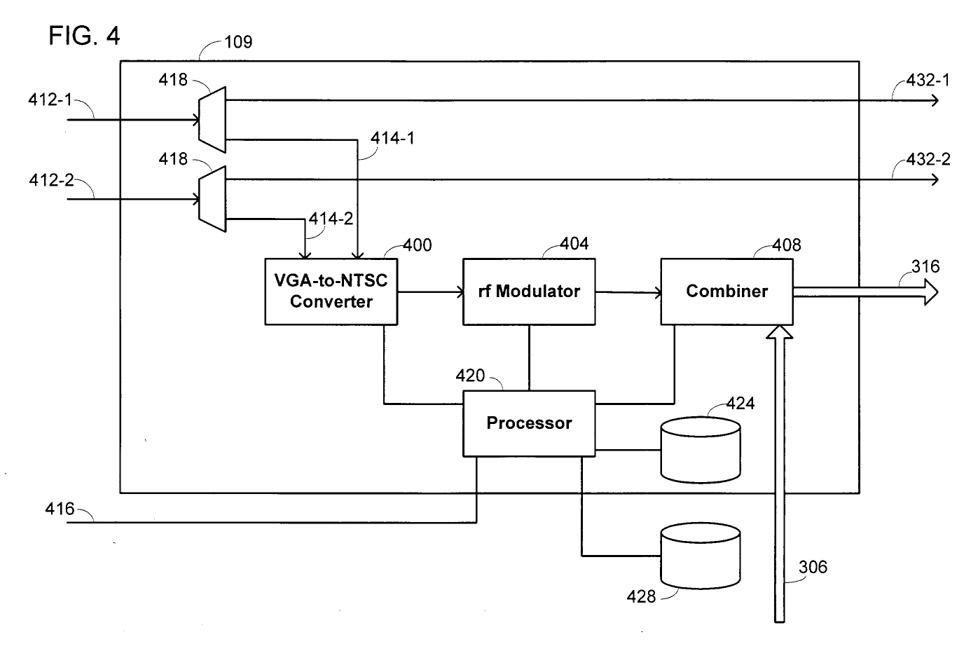

FIG. 4 provides a schematic illustration of a structure for the internet data module 109 that may be used in an embodiment. The illustration is provided for conversion of VGA signals into NTSC signals, but it will be appreciated by those of skill in the art that equivalent techniques may be used for conversion of any type of computer data streams into any type of television video signals. The received computer data stream 308 is shown comprising VGA signals 412, each of which is split by a splitter 418. An equivalent 432 to each of signals 412 is output from the internet data module 109 to define the signal 312 that is transmitted to the computational device 320. The other equivalents 414 to signals 412 are provided to a VGA-to-NTSC converter 400, specific exemplary structures for which are described further below. Operation of the VGA-to-NTSC converter 400 is controlled by a processor 420 to select one of the received VGA signals 412 and to convert it to an NTSC signal. The resulting NTSC signal is provided to an rf modulator 404, which acts in accordance with control by the processor 420 to modulate the NTSC signal onto a particular channel. The modulated signal is then combined with the converted television signal 306 received from the TV module 302 with a combiner 408 to produce the combined signal 316. Coordinated control of each of the VGA-to-NTSC converter 400, rf modulator 404, and combiner 408 permits the selected one of the received VGA signals 412 to be provided on the combined signal 316 with the desired channel.

In some embodiments, the internet data module 109 additionally includes a storage device 424 in communication with the processor 420 for receiving a copy of modulated signals from the rf modulator 404. This permits retrieval of the stored signals from the storage device 424 as may be desired for replay. Thus, merely by way of example, the storage capacity of the internet data module 109 may be used in an embodiment where a parent wishes to monitor use of a computational device 320 by a child, in particular to review which Internet web sites may have been accessed by the child. If the child uses the computational device 320 when the parent is absent, the child's activity may be recorded on the storage device 424 and may later be replayed over the video appliance 324 for review by the parent. More generally, the storage capacity of the internet data module 109 may be used to review any signals that are transmitted to the computational device 320 from the internet data module 109 and provided at a later time to the video appliance 324.

While the storage device 424 is shown internal to the internet data module 109, in other embodiments an external data store 428 may be used alternatively or in addition. The external data store 428 could use a moveable storage medium, such as in an embodiment where a video-cassette recorder (“VCR”) is used for storage. Such embodiments thus provide an alternative mechanism for using the monitoring capabilities of the internet data module 109. For example, where a parent wishes to monitor use of a computational device 320 by a child, the child's activity could be recorded on a video cassette for later review by the parent.

The processor 420 may also be equipped with an interface 416 that permits the processor to be programmed. In one embodiment, the programming may be provided over the interface 416 with one of the computational devices 320, although the interface may be used with any suitable programming device known to those of skill in the art. Such programming may be used to define the operation of the internet data module 109, including defining such parameters as which data streams are to be mapped onto which channels of the combined signal 316. In addition, the programming capability may be used to define parameters under which signals should be recorded on the storage device 424, such as by specifying the time or other conditions to perform such recording. The interface capability with the processor 420 may also be used to request replay of stored signals when desired.

While FIG. 4 shows the VGA-to-NTSC converter 400 configured to select one of a plurality of VGA signals 412 for conversion and transmission to an rf modulator 404, in alternative embodiments a plurality of rf modulators 404 may be provided. In such instances, the VGA-to-NTSC converter 400 may be configured to transmit each of a plurality of VGA signals to respective ones of the plurality of rf modulators 404 after conversion to an NTSC signal. Each of the rf modulators 404 may then modulate the signals differently so that when they are combined with the converted television signal 306 by the combiner 408, they become accessible on different channels by the video appliance 324. This provides the access to multiple data streams to enable such embodiments described above.

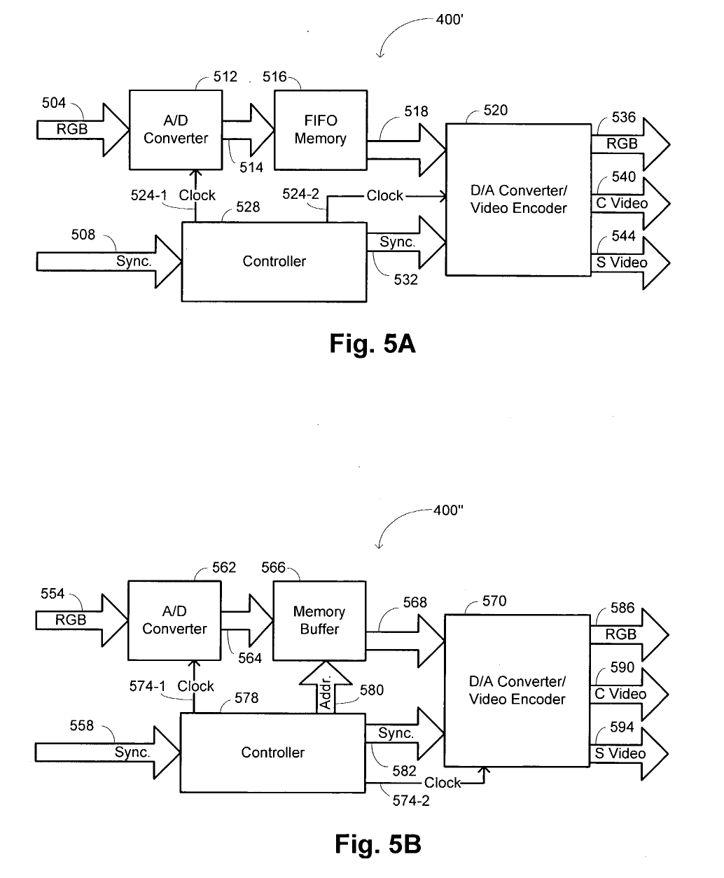

The functionality of the VGA-to-NTSC converter 400 to convert received computer video signals into television video signals may be realized in a variety of different ways. Some such mechanisms are described in connection with FIGS. 5A and 5B, although other mechanisms will also be known to those of skill in the art. A first example of a VGA-to-NTSC converter in a specific embodiment is shown in FIG. 5A and denoted 400′. As indicated, the incoming VGA signal 412 is initially separated into a standard red-green-blue (“RGB”) signal 504 and a sync signal 508. The sync signal 508 itself may comprise vertical and horizontal sync signals or may comprise a composite sync signal. The RGB signal 504 includes information defining pixel color information and the sync signal 508 includes information defining how to synchronize the information to produce color images for display.

The RGB signal 504 is provided to an analog-to-digital converter 512 for conversion to a digital signal that is provided to a first-in-first-out (“FIFO”) memory 516. The sync signal 508 is provided to a controller 528. A combination digital-to-analog converter and video encoder receives signals 518 and 532 respectively from the FIFO memory 516 and controller 528 to produce output RGB signals 536, C video signals 540, and S video signals 544 that define the resultant NTSC signal. Operation of the device is coordinated with clock signals 524-1 and 524-2 from the controller to the analog-to-digital converter 512 and digital-to-analog converter/video encoder 520 respectively.

The operation of the controller 528 to effect the conversion may be illustrated with specific examples of typical video characteristics, with other examples being evident to those of skill in the art after reading this description. For example, in one embodiment, the VGA signals 412 define a non-interlaced picture having a 60-Hz refresh rate and a horizontal scan frequency that is twice the NTSC horizontal scan frequency. In such an instance, the controller 528 is configured so that the first odd-number scanline shown in the VGA image is stored in the FIFO memory 516. The stored scanline is then sent out at half speed and encoded to an NTSC video signal. Subsequently, the next odd scanline is stored in the FIFO memory 516. The even-numbered scanlines are subsequently handled in the same fashion, resulting in an interlaced NTSC signal at a 60-Hz refresh rate. The operation may be complicated when the refresh rate of the VGA signals 412 differs from the desired refresh rate of the output television video signals, such as when VGA signals 412 are to be converted to PAL signals. In such instances, an additional driver may be provided to set all VGA modes to the 50-Hz rate used by PAL signals, with the horizontal scan rate for PAL output still being made by halving the VGA horizontal scan rate.

In instances where the VGA refresh rate is substantially the same as the refresh rate of the television video signals to be output, a similar conversion technique may be used even where the horizontal sync rate of the VGA signals is not exactly twice the horizontal sync rate of the television video signals. In such instances, the controller 528 may be provided with information regarding the ratio of sync rates, thereby defining how many VGA scanlines correspond to a single television scanline. The translation is done as before, but with the conversion being performed on the basis of the ratio of sync rates rather than for every second scanline. There is no a priori requirement with such a technique that the ratio of sync rates be an integer.

Another structure for the VGA-to-NTSC converter is shown in FIG. 5B and designated 400″. As for the embodiment shown in FIG. 5A, the incoming VGA signal 412 is initially separated into a standard RGB signal 554 and a sync signal 558, which may comprise vertical and horizontal sync signals or may comprise a composite sync signal. The RGB signal 554 is provided to an analog-to-digital converter 562 for conversion to a digital signals that is provided to a memory buffer 566, and the sync signal 558 is provided to a controller 578. A combination digital-to-analog converter and video encoder 570 receives signals 568 and 582 respectively from the memory buffer 566 and the controller 578 to produce output RGB signals 586, C video signals 590, and S video signals 594 that define the resultant NTSC signal. In addition to operation of the device being coordinated with clock signals 574-1 and 574-2 from the controller to the analog-to-digital converter 562 and the digital-to-analog converter/video encoder 570 respectively, addressability 580 is provided from the controller 578 to the memory buffer 566. Thus, one part of the device 400″ digitizes the incoming VGA signals 412 and stores the digitized signals in the memory buffer 566. Another part of the device 400″ reads the digitized signals from the memory buffer 566 at the rate appropriate for the output television video signals.

In some instances, additional capability may be provided to the VGA-to-NTSC converter 400, such as with devices that reduce flicker, provide zooming capability, and change resolution characteristics.

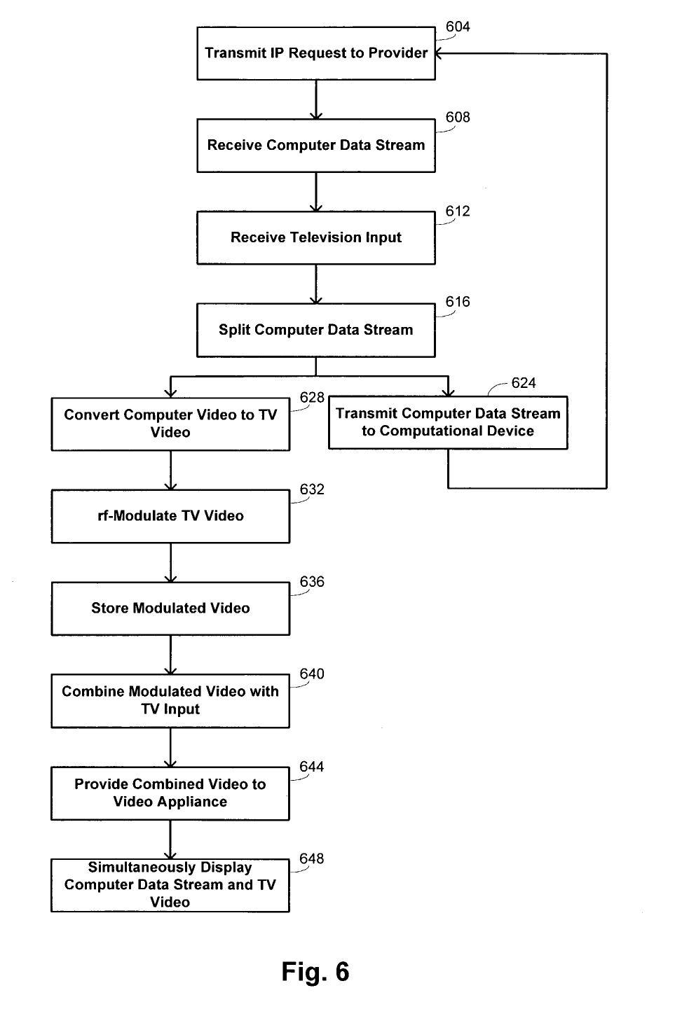

The operation of the architecture described in connection with FIGS. 1A-5B is conveniently summarized with the flow diagram shown in FIG. 6. In this diagram, a series of blocks are provided that illustrate functions that may be performed as part of delivering a computer data stream to a video appliance in accordance with embodiments of the invention. Neither the order nor the number of functions indicated is required, and some embodiments of the invention include the performance of fewer or more of the indicated functions and/or include the performance of some of the indicated functions in a different order. Furthermore, while some of the functions may be performed using the apparatus discussed above, they may also be performed with alternative and/or equivalent apparatus, as will be known to those of skill in the art after reading this disclosure.

A method for delivering a computer data stream to a video appliance may begin at block 604 with transmission of an IP request to a provider. Such a request may originate with one of the computational devices 320, such as in cases where a monitoring function is being performed, or may originated with one of the video appliances 324, such as in cases where supplementary internet information is to be displayed for informational purposes. Transmission of the request to the provider may be coordinated by the internet data module 109. The corresponding computer data stream is received at block 608 and television input is received at block 612. At block 616, the computer data stream is split so that at block 624, an equivalent to the computer data stream may be transmitted to the computational device 320. The figure indicates those embodiments in which the IP requests are being initiated by the computational device by showing a loop of such requests as the computer data stream is provided to the computational device.

The other equivalent to the computer data stream is converted to a television video signal at block 628. At block 632, the converted signal is rf-modulated to permit its identification according to a tunable channel. At block 636, the modulated signal may be stored to permit its later recovery for display. At block 640, the television input received at block 612 is combined with the modulated converted computer data stream. The combined video signal is then provided to the video appliance at block 644 so that the computer data stream and television video may be viewed simultaneously on the video appliance as indicated at block 648. In embodiments where the requests for the computer data stream are initiated by the video appliance instead of by the computational device, the loop of such requests could be defined with respect to block 648 instead of with respect to block 624.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for delivering a data stream having a computer video signal to a video appliance within a customer premises, the method comprising:
isolating a transport medium internal to the customer premises from a transport medium external to the customer premises such that operational changes to one of the internal and external transport media do not affect the other of the internal and external transport media;
receiving the data stream from the external transport medium;
receiving a television signal from the external transport medium;
combining the computer video signal with the television signal; and
transmitting the combined computer video signal and television signal to the video appliance over the internal transport medium.

2. The method recited in claim 1 wherein combining the computer video signal with the television signal comprises:
converting the computer video signal to a converted television video signal; and
combining the converted television video signal with the television signal.

3. The method recited in claim 2 further comprising rf modulating the converted television video signal, whereby the converted television video signal may be selected for display on the video appliance by tuning the video appliance.

4. The method recited in claim 2 further comprising storing the converted television video signal.

5. The method recited in claim 4 further comprising retrieving the stored converted television video signal prior to combining the converted television video signal with the television signal.

6. The method recited in claim 2 further comprising:
receiving a second data stream having a second computer video signal from the external transport medium; and
combining the second computer video signal with the television signal.

7. The method recited in claim 6 wherein combining the second computer video signal with the television signal comprises:
converting the second computer video signal to a second converted television video signal; and
combining the second converted television video signal with the television signal.

8. The method recited in claim 7 further comprising:
rf modulating the converted television video signal with a first modulation; and
rf modulating the second converted television video signal with a second modulation,
whereby either of the converted television video signals may be selected for display on the video appliance by tuning the video appliance.

9. The method recited in claim 2 further comprising displaying the converted television video signal on the video appliance.

10. The method recited in claim 9 wherein displaying the converted television signal on the video appliance comprises displaying the converted television signal with a picture-in-picture capability of the video appliance.

11. The method recited in claim 1 further comprising transmitting the data stream to a computational device within the customer premises over the internal transport medium.

12. The method recited in claim 11 further comprising receiving a request for the data stream from the computational device over the internal transport medium, wherein receiving the data stream is performed in response to the request.

13. The method recited in claim 1 wherein receiving the television signal from the external transport medium comprises:
receiving encoded telecommunication information from the external transport medium;
decoding the encoded telecommunication information with an addressable set-top box disposed external to the customer premises; and
generating the television signals from the decoded telecommunication information.

14. The method recited in claim 13 wherein receiving the television signal further comprises:
receiving an instruction to change a state of the addressable set-top box; and
changing the state of the addressable set-top box in accordance with the received instruction.

15. The method recited in claim 1 wherein the data stream is received from an Internet site.

16. A network interface device comprising:
an isolation device adapted to isolate a transport medium internal to a customer premises from a transport medium external to the customer premises such that operational changes to one of the internal and external transport media do not affect the other of the internal and external transport media;
a first interface coupled with the isolation device and adapted to communicate with the external transport medium;
a second interface coupled with the isolation device and adapted to communicate with the internal transport medium; and
an internet data module coupled with the first and second interfaces and adapted to receive a television signal and a data stream having a computer video signal from the external transport medium, and to transmit a combination of the television signal and the computer video signal to a video appliance over the internal transport medium.

17. The network interface device recited in claim 16 wherein the internet data module comprises:
a conversion element adapted to convert the computer video signal to a converted television video signal;
a combiner adapted to combine the converted television video signal with the television signal; and
a processor in communication with and adapted to coordinate operation of the conversion element and the combiner.

18. The network interface device recited in claim 17 wherein:
the internet data module further comprises an rf modulator adapted to modulate the converted television video signal; and
the processor is further in communication with and adapted to coordinate operation of the rf modulator.

19. The network interface device recited in claim 17 wherein the internet data module further comprises a storage device adapted to store the converted television video signal.

20. The network interface device recited in claim 17 wherein the processor is configured for communication with a storage device disposed external to the internet data module.

21. The network interface device recited in claim 17 wherein:
the conversion element is further adapted to convert a second computer video signal to a second converted television video signal; and
the combiner is further adapted to combine the second converted television video signal with the converted television video signal and the television signal,
whereby the internet data module is further adapted to receive a second data stream having the second computer video signal and to transmit a combination of the television signal, the computer video signal, and the second computer video signal to the video appliance.

22. The network interface device recited in claim 21 wherein the internet data module further comprises:
a first rf modulator adapted to modulate the converted television video signal with a first modulation; and
a second rf modulator adapted to modulate the second converted television video signal with a second modulation.

23. The network interface device recited in claim 17 wherein the processor includes an interface for accepting programming information.

24. The network interface device recited in claim 16 further comprising an addressable set-top box adapted to receive encoded telecommunication information from the external transport medium and to generate the television signal from the encoded telecommunication information for transmission to the internet data module.

25. The network interface device recited in claim 24 wherein the internet data module and addressable set-top box are disposed within a common housing.

26. A network interface device comprising:
means for isolating a transport medium internal to a customer premises from a transport medium external to the customer premises such that operational changes to one of the internal and external transport media do not affect the other of the internal and external transport media;
means for receiving a data stream having a computer video signal from the external transport medium;
means for receiving a television signal from the external transport medium;
means for combining the computer video signal with the television signal; and
means for transmitting the combined computer video signal and television signal to a video appliance over the internal transport medium.

27. The network interface device recited in claim 26 wherein the means for combining the computer video signal with the television signal comprises:
means for converting the computer video signal to a converted television video signal; and
means for combining the converted television video signal with the television signal.

28. The network interface device recited in claim 27 further comprising means for rf modulating the converted television signal.

29. The network interface device recited in claim 26 wherein the means for receiving the television signal from the external transport medium comprises:
means for receiving encoded telecommunication information from the external transport medium;
means for decoding the encoded telecommunication information; and
means for generating the television signals from the decoded telecommunication information.
